(19) United States
(12) Patent Application Publication
(10) Pub. No.: US 2025/0384425 A1
(43) Pub. Date: Dec. 18, 2025

(54) SYSTEMS AND METHODS FOR PROVIDING ACCOUNT TRANSACTION CONTROL AND MANAGEMENT

(71) Applicant: Wells Fargo Bank, N.A., San Francisco, CA (US)

(72) Inventors: Young M. Yang, San Francisco, CA (US); Michelle W. Chan, San Francisco, CA (US); Robin H. Lo, San Francisco, CA (US); Tiffany N. Twilley, Foster City, CA (US); Jessica DeGregoire, Concord, CA (US)

(21) Appl. No.: 18/741,344

(22) Filed: Jun. 12, 2024

(51) Int. Cl. G06Q 20/36

(52) U.S. Cl. CPC G06Q 20/363

(57) ABSTRACT

Systems, apparatuses, methods, and computer program products are disclosed for providing improved account transaction control and management. An example method includes receiving a transaction attempt associated with a payment account of a user, where the payment account includes an initial transaction limit and a secondary transaction limit. The example method further includes determining whether a transaction amount of the transaction attempt exceeds the initial transaction limit. The example method also includes providing a first limit violation notification to the user and receiving a limit override confirmation in response to the limit violation notification, where the limit override confirmation comprises a mobile driver's license (mDL) associated with the user. The example method also includes authenticating the user based on the mDL and, in response to successfully authenticating the user based on the mDL, enabling the secondary transaction limit associated with the payment account.

### BACKGROUND

Conventional payment systems may allow access to payment accounts and/or funds via mobile computing devices. However, conventional payment systems and techniques exhibit numerous drawbacks, inefficiencies, and limitations.

### BRIEF SUMMARY

Conventional payment systems (e.g., as provided by banks or financial institutions) may allow users to set up spending limits associated with various payment accounts and/or payment methods. This is beneficial from both a financial wellness standpoint and a fraud prevention perspective. However, there may be certain circumstances in which a user legitimately wishes to make a purchase that exceeds a preset spending limit associated with a respective payment account. In this regard, enterprises have not had an efficient, effective way to securely set up temporary spending limits or caps on respective payment accounts for user-defined timeframes. Furthermore, the conventional methods for imposing spending limits and caps are limited and may result in high costs, wasted technological resources due to computational complexity, and insecure means of ensuring the safe access to funds.

For example, various enterprises (e.g., financial institutions) may enable a user to configure a single, permanent spending limit for a respective payment account (e.g., a checking account, savings account, and/or the like). However, such permanent spending limits require that a user gain access to their account (e.g., log in to a web-based user account associated with a respective enterprise) any time the user wishes to configure and/or update the permanent spending limit for the respective payment account. It is therefore computationally complex and time-intensive to instill or update a spending limit for respective payment account using conventional payment systems.

This becomes especially apparent in the event that a transaction attempt is denied at a point-of-sale (POS) terminal (e.g., a POS terminal at a merchant location). For instance, if a transaction attempt exceeds the permanent spending limit for a respective payment account, the user may have to gain access to the payment account, change the permanent spending limit, and then re-attempt the transaction at the POS in order to complete the transaction. This leads to excess computational resource consumption on the part of the user's mobile device and network provider, as well as for the enterprise that manages the payment account and/or user account associated with the user, and even for the merchant associated with the POS, as the merchant may be required to facilitate multiple transaction attempts on behalf of the user.

Various enterprises may also offer conventional smart mobile wallets (e.g., digital wallets) that allow a user to access and/or utilize one or more payment methods via a user device (e.g., a smartphone) to execute payment transactions. However, while a smart mobile wallet conveniently allows a user to securely carry multiple forms of payment (e.g., multiple credit cards, bank cards) and may provide a wide range of advantages over traditional payment methods (e.g., physical currency, paper checks), a conventional smart mobile wallet lacks the ability to facilitate the management (e.g., configuration and/or update) of various transaction limits associated with a respective payment account. Thus, technical challenges arise for users who wish to efficiently enable, adjust, and/or override various transaction limits associated with one or more payment accounts.

Therefore, it may be beneficial to enable a user to configure a payment account (e.g., a checking account, savings account, credit account, and/or the like) with a plurality of transaction limits. Furthermore, it may be desirable to enable such operations via a smart mobile wallet associated with the user. In this regard, embodiments described herein are configured to enable a user to generate an initial transaction limit (e.g., a first spending limit value) and a secondary transaction limit (e.g., a second, higher spending limit value relative to that of the initial transaction limit) for a payment account associated with the user. Furthermore, example embodiments described herein enable a user to link (e.g., connect, integrate, associate) the payment account to a smart mobile wallet on a user device associated with the user.

Moreover, in contrast to conventional payment systems, example embodiments described herein enable a user to efficiently and securely override a predetermined transaction limit (e.g., an initial transaction limit) associated with a payment account without requiring the user or an enterprise representative to access an account (e.g., a payment account and/or user account) to update the predetermined transaction limit. For example, example embodiments described herein may be configured to leverage a mobile driver's license (mDL) associated with the user in order to facilitate one or more user authentication operations associated with generating, managing, updating, and/or utilizing one or more of an initial transaction limit and/or secondary transaction limit associated with a payment account of the user.

In contrast to conventional payment systems and techniques for managing spending limits or caps associated with a payment account, example embodiments described herein comprise a smart mobile wallet management system configured to generate and manage initial transaction limits and secondary transaction limits for a respective payment account associated with a user. In example embodiments, the smart mobile wallet management system may, at least in part, (i) receive an account limitation configuration request from a user device associated with a user, (ii) generate, based on the account limitation configuration request, an initial transaction limit and a secondary transaction limit associated with a payment account of the user, (iii) receive a transaction attempt associated with the payment account, (iv) determine whether a transaction amount of the transaction attempt exceeds the initial transaction limit, (v) in response to determining the transaction amount exceeds the initial transaction limit, provide a first limit violation notification to the user, (vi) receive, based on the first limit violation notification, a first limit override confirmation from the user device, (vii) authenticate, based on the first limit override confirmation, the user based on an mDL associated with the user, and (viii) in response to authenticating the user, enable the secondary transaction limit associated with the payment account.

Accordingly, the present disclosure sets forth systems, methods, and apparatuses that provide user-configurable transaction limits for use in executing various transactions (e.g., monetary transactions, mDL-based transactions). There are many advantages of these, and other embodiments described herein. One advantage the smart mobile wallet management system provides is an improvement to the functioning of the computing infrastructure of an enterprise (e.g., a bank or financial institution), such as by reducing the burden on computing resources. For instance, the smart mobile wallet management system described herein reduces the complexity of updating preset spending limits or caps for a payment account by, among other things, automating processes such as identifying a smart mobile wallet associated with a user, authenticating a user based on an mDL stored in the smart mobile wallet associated with the user, enabling initial transaction limits, secondary transaction limits, and/or temporary transaction override limits for one or more payment accounts, and providing secure access to one or more payment accounts via the smart mobile wallet associated with the user.

Another advantage of the smart mobile wallet management system, as described herein, is an improvement to network security technologies and/or authentication technologies by providing increased security for data, payment accounts, and/or valuable resources (e.g., financial resources) related to users and/or enterprises by utilizing mDLs associated with respective users to authenticate the respective users. In this regard, the smart mobile wallet management system may be employed to remotely authenticate a user based on a respective mDL. As will be described in greater detail below, utilizing mDLs that have been issued by legally entitled entities (e.g., government agencies) adds an additional layer of trust to each transaction and/or operation facilitated by the smart mobile wallet management system. Furthermore, utilizing mDLs to authenticate and/or verify users ensures that only intended parties (e.g., users, users) are able to access, manage, and/or utilize one or more initial transaction limits, secondary transaction limits, and/or temporary transaction override limits for one or more payment accounts.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating a smart mobile wallet management system.

FIG. 2 illustrates a schematic block diagram of example circuitry embodying a system device that may perform various operations in accordance with some example embodiments described herein.

FIG. 3 illustrates a schematic block diagram of example circuitry embodying a user device that may perform various operations in accordance with some example embodiments described herein.

FIG. 4 illustrates an example flowchart diagram for providing account transaction control and management in accordance with some example embodiments described herein.

FIG. 5 illustrates an example flowchart diagram for allowing or denying a respective transaction in accordance with some example embodiments described herein.

FIG. 6 illustrates an example flowchart diagram for configuring a temporary transaction override limit in accordance with some example embodiments described herein.

FIG. 7 illustrates an example flowchart diagram for generating an account limitation violation report and one or more recommendations in accordance with some example embodiments described herein.

FIG. 8 illustrates an example user interface associated with a smart mobile wallet of a user in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “user device” or “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server,” “server device,” or “server system” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

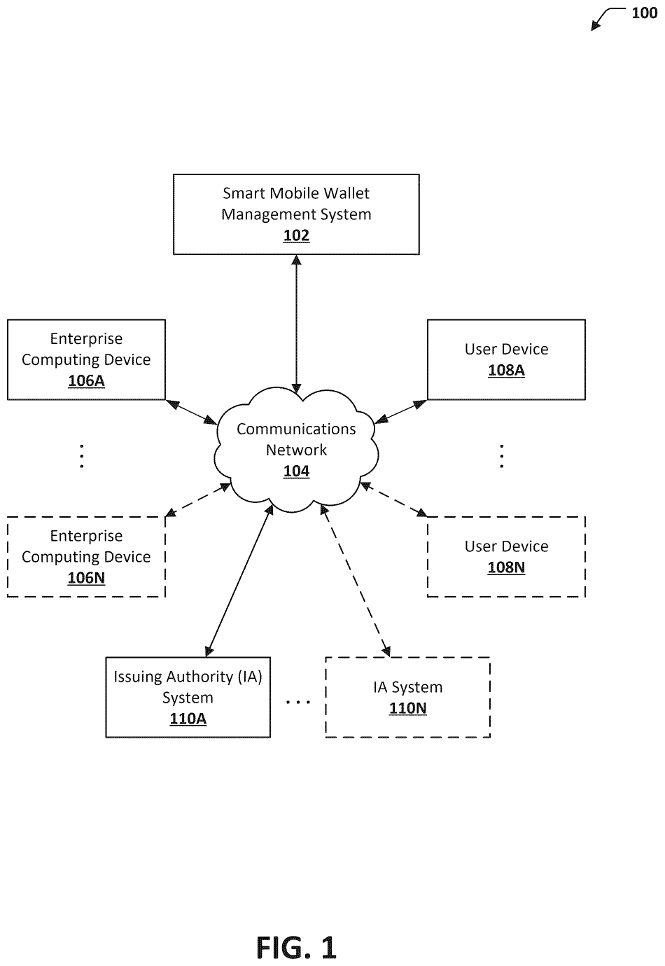

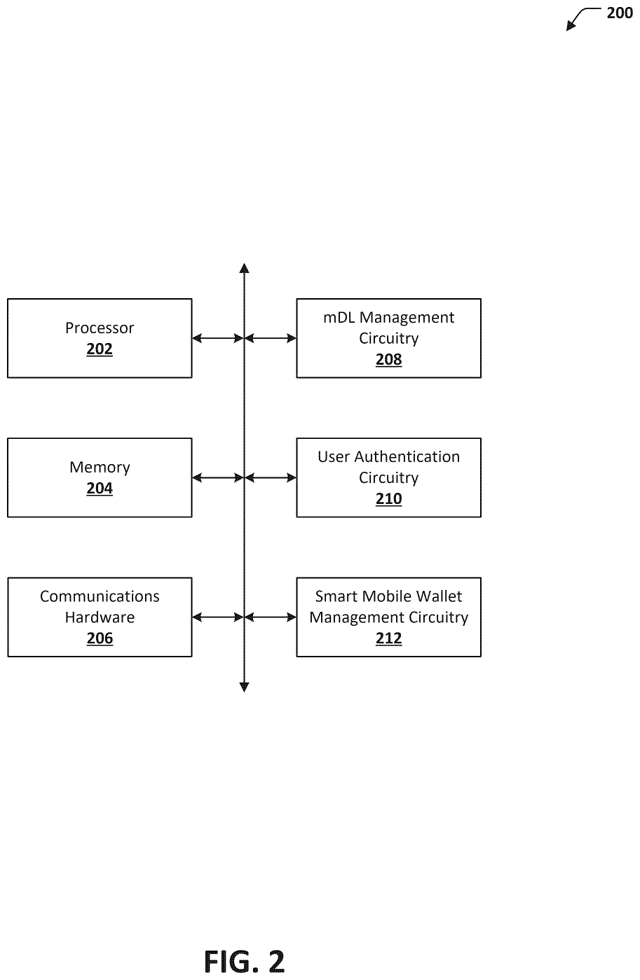

Example embodiments described herein may be implemented using any of a variety of computing devices or servers. To this end, FIG. 1 illustrates an example environment 100 within which various embodiments may operate. As illustrated, a smart mobile wallet management system 102 may receive and/or transmit information via communications network 104 (e.g., the Internet) with any number of other computing devices and/or computing systems, such as one or more of enterprise computing devices 106A-106N, user devices 108A-108N, and/or issuing authority (IA) systems 110A-110N. The smart mobile wallet management system 102 may be implemented as one or more computing devices or servers, which may be composed of a series of components. Particular components of the smart mobile wallet management system 102 are described in greater detail below with reference to apparatus 200 in connection with FIG. 2.

In various embodiments, the smart mobile wallet management system 102 may be associated with an enterprise (e.g., a financial institution, bank, and/or the like) and may be configured to manage various smart mobile wallet processes for users associated with said enterprise. For example, the smart mobile wallet management system 102 may be configured to manage, execute, initiate, and/or otherwise facilitate one or more account transaction control and management processes, transaction limitation configuration processes, payment account linking processes, payment account transaction processes, smart mobile wallet processes, mDL authentication processes, user identity verification process, user authentication processes, and/or the like for a plurality of users associated with the respective enterprise.

In this regard, various users associated with an enterprise may interact with the smart mobile wallet management system 102 via a software application instance, where the software application instance may be configured to facilitate one or more of the various account transaction control and management processes, smart mobile wallet processes, mDL authentication processes, and/or other processes described herein. In various embodiments, the software application instance associated with the smart mobile wallet management system 102 may be installed and/or downloaded to a user device (e.g., a user device 108A configured as a mobile device, laptop, and/or the like) and may present one or more user interface configurations to a respective user.

As such, the software application instance associated with the smart mobile wallet management system 102 may be configured to guide a user through the various steps of a transaction limitation configuration process (e.g., transaction limit generation process, transaction limit override process, and/or the like) that may require a user to be authenticated based on a corresponding mDL. For example, the software application instance associated with the smart mobile wallet management system 102 may be configured to cause display of various interactive user interface elements to the user that are configured to enable the user to manage one or more portions of smart mobile wallet data (e.g., payment account data, payment card data, data associated with an initial transaction limit and/or secondary transaction limit, and/or the like) and/or user data (e.g., user attribute data, user profile data, user account data, and/or other user data).

In some embodiments, the software application instance may be configured to enable a user to access a smart mobile wallet (e.g., a digital wallet) configured to manage one or more of a user's mDL, payment accounts (e.g., credit accounts, checking accounts, savings accounts, investment accounts), and/or payment cards (e.g., credit cards, debit cards, and/or the like associated with the user's payment accounts) that are associated with a respective enterprise employing the smart mobile wallet management system 102. Additionally or alternatively, in various embodiments, the software application instance associated with the smart mobile wallet management system 102 may be configured to enable a user to access a software application framework related to a respective enterprise by, for example, providing (e.g., transmitting, enabling, toggling, configuring, etc.) one or more access permissions for a user device (e.g., a user device 108A) associated with the user, where the one or more access permissions enable the user device to access the software application framework associated with the enterprise.

As described herein, the smart mobile wallet management system 102 may be configured to generate one or more transaction limits for a payment account associated with a respective user. In some examples, such transaction limits may comprise an initial transaction limit, a secondary transaction limit, and/or a temporary transaction override limit. Such transaction limits may be associated with a monetary value (e.g., $50, $100, $500, $2,000, or any other value) such that one or more transaction attempts executed by a respective user (e.g., retail purchases, online purchases, and/or the like) may be denied (or flagged for denial) if a total dollar amount associated with one or more goods and/or services the user is attempting purchase is greater than one or more of the transaction limits.

Additionally, an initial transaction limit, a secondary transaction limit, and/or a temporary transaction override limit may be associated with different respective monetary values. In various examples, an initial transaction limit may be a first transaction limit enforced by the smart mobile wallet management system 102 and may have a lower monetary value relative to that of a secondary transaction limit. As such, a secondary transaction limit may be a second transaction limit enforced by the smart mobile wallet management system 102 and may have a higher monetary value relative to that of an initial transaction limit. As a non-limiting example, an initial transaction limit may be associated with a monetary value of $150 and a secondary transaction limit may be associated with a monetary value of $300 for a given payment account.

Furthermore, in some examples, a temporary transaction override limit may be enabled by the smart mobile wallet management system 102 to temporarily override both an initial transaction limit and a secondary transaction limit associated with a common payment account. In some examples, a temporary transaction override limit may have a higher monetary value relative to an initial transaction limit and a secondary transaction limit. Alternatively, in some other examples, a temporary transaction override limit may have a value associated with an available balance of the corresponding payment account such that no limitations are placed on any attempted transactions made utilizing the corresponding payment account for a predetermined amount of time. As a non-limiting example, if a particular user knows they will be embarking on a planned vacation, the smart mobile wallet management system 102 may be configured to activate a temporary transaction override limit of $5000 for a respective payment account. As such, one or more transactions made during the planned vacation may not exceed a pre-configured initial transaction limit (e.g., $400) and/or a pre-configured secondary transaction limit (e.g., $750) and may not be denied (or flagged for denial) by the smart mobile wallet management system 102.

Furthermore, one or more of an initial transaction limit, a secondary transaction limit, and/or a temporary transaction override limit may be associated with various time periods (e.g., daily, weekly, monthly, bi-monthly, and/or the like). For example, if an initial transaction limit (e.g., $100) is associated with a daily time period (e.g., 12:00 AM-11:59 PM), one or more transactions executed during a respective day may be totaled by the smart mobile wallet management system 102 to determine if the initial transaction limit has been exceeded for that respective day. Similarly, as another example, if an initial transaction limit (e.g., $500) is associated with a weekly time period (e.g., a seven-day time period from a respective Sunday until the following Saturday), one or more transactions executed during a calendar week may be totaled by the smart mobile wallet management system 102 to determine if the initial transaction limit has been exceeded for that calendar week.

In some circumstances, the smart mobile wallet management system 102 may be configured to deny one or more transactions (e.g., retail purchase transactions, online purchase transactions, and/or the like) that exceed (or are expected to exceed) one or more of an initial transaction limit, a secondary transaction limit, and/or a temporary transaction override limit. Additionally or alternatively, in some circumstances, the smart mobile wallet management system 102 may be configured to generate and/or transmit one or more limit violation notifications to a user device (e.g., user device 108A) and/or smart mobile wallet associated with a respective user when a transaction limit (e.g., an initial transaction limit, a secondary transaction limit, and/or a temporary transaction override limit) is exceeded during a transaction attempt. Furthermore, the smart mobile wallet management system 102 may be configured to enable the respective user to override a first transaction limit (e.g., an initial transaction limit associated with a first value (e.g., $100)) and activate a second transaction limit (e.g., a secondary transaction limit with a second value (e.g., $500)) such that the respective user may be allowed to execute one or more transactions exceeding the first transaction limit (e.g., the initial transaction limit) and up to a total dollar amount less than or equal to equal to the second transaction limit (e.g., the secondary transaction limit).

In some examples, when the second transaction limit associated with a payment account is activated during a transaction attempt (e.g., the secondary transaction limit), the second transaction limit is only enabled for the duration of the transaction attempt. For example, the first transaction limit (e.g., the initial transaction limit) may be overridden such that the second transaction limit (e.g., the secondary transaction limit) is enabled on a one-time basis so that the transaction attempt may be allowed and then the first transaction limit may be reinstated after completion of the transaction attempt. Alternatively, in various examples, once the second transaction limit (e.g., the secondary transaction limit) is enabled for the respective payment account, the second transaction limit may remain active according to a time period associated with the second transaction attempt such that one or more transactions exceeding the first transaction limit (e.g., the initial transaction limit) may be executed up to a total dollar amount less than or equal to the second transaction limit (e.g., the secondary transaction limit).

In various examples, an initial transaction limit, a secondary transaction limit, and/or a temporary transaction override limit may be associated with respective payment account information such as an account number, routing number, and/or other identifying information. Additionally, an initial transaction limit, a secondary transaction limit, and/or a temporary transaction override limit may be associated with various identifying information associated with the corresponding payment account of the user, where such identifying information may be used by the smart mobile wallet management system 102 to link an initial transaction limit, a secondary transaction limit, and/or a temporary transaction override limit to the payment account of the user.

Furthermore, the initial transaction limit, a secondary transaction limit, and/or a temporary transaction override limit may be associated with one or more digital payment cards (e.g., fashioned after a conventional debit card, credit card, and/or the like) that may be stored by and/or linked to the one or more smart mobile wallets and utilized to execute various transactions via a user device (e.g., user device 108A). In this regard, the smart mobile wallet management system 102 may be configured to cause an appropriate amount of funds to be withdrawn from the one or more payment accounts associated with an initial transaction limit, a secondary transaction limit, and/or a temporary transaction override limit based on any legitimate transaction executed utilizing a payment method (e.g., payment card, digital payment card, account number, routing number, and/or the like) associated with the one or more payment accounts.

In some embodiments, the smart mobile wallet management system 102 may be configured to facilitate the execution of one or more processes related to an initial transaction limit, a secondary transaction limit, and/or a temporary transaction override limit for a respective user based on authenticating an mDL associated with the respective user. As a non-limiting example, the smart mobile wallet management system 102 may be configured to authenticate a user based on a respective mDL associated with the user before enabling secondary transaction limit or temporary transaction override limit.

In this regard, the smart mobile wallet management system 102 may be configured to store, integrate with, manage, and/or utilize one or more mDLs (and/or data related to the one or more mDLs (e.g., mDL identifying information, cryptographic key information)) associated with a respective user in order to facilitate the various operations described herein. As used herein, the term “mDL” covers various mobile (e.g., digital) identity credential types associated with a respective user including mobile driver's licenses and mobile identification cards. An mDL may be an electronically managed data structure configured to be accessed, processed, and/or otherwise utilized by the smart mobile wallet management system 102 for various user authentication processes.

In this regard, an mDL may be configured to store or point to (e.g., programmatically reference) various credential data associated with a respective user including, but not limited to, personally identifiable information (PII) (e.g., given name, family name, name prefix, name suffix, driver's license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. Additionally, an mDL may be configured to store and/or point to various cryptographic key information (e.g., public key information used to identify the mDL, a corresponding user device, and/or a corresponding user) and/or originating IA data (e.g., cryptographic key information and/or identifying data associated with an originating IA).

An mDL may be issued (e.g., provisioned) to a respective user by an IA system 110A associated with a particular IA. An IA may be an entity that is legally entitled (or otherwise recognized as the relevant authority) to issue credentials, such as driver's licenses and/or other identification cards. An IA system 110A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 110A may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally or alternatively, in some embodiments, an mDL may be administered, managed, employed, and/or otherwise utilized by the smart mobile wallet management system 102 in compliance with various standards set forth by the American Association of Motor Vehicle Administrators (AAMVA). Additionally or alternatively, in some embodiments, an mDL may be administered, managed, employed, and/or otherwise utilized by the smart mobile wallet management system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver's license) associated with a user and may comprise and/or be associated with the same data as the legal credential. In some embodiments, an mDL associated with a user may be stored in a storage device (e.g., a server system) of an IA system 110A and one or more portions of credential data related to the mDL may be retrieved in real time, or near-real time, during a transaction associated with the user (e.g., an online transaction requiring user authentication, user age verification, and/or the like). Additionally or alternatively, once an mDL is issued to a user by a respective IA (e.g., by way of a corresponding IA system 110A), the mDL may be stored locally on a user device associated with the user (e.g., user device 108A) such that the mDL may be used without relying on a communications network (e.g., communications network 104). Additionally or alternatively, in some embodiments, an mDL may be stored in a smart mobile wallet associated with the user and managed by the smart mobile wallet management system 102, and the mDL may be accessed and/or utilized by the user via the smart mobile wallet to execute various mDL-based transactions.

In some examples, an IA may provision an mDL to a particular user device (e.g., user device 108A) associated with a user such that the mDL is associated with various user device identification data related to the particular user device (e.g., cryptographic identification data such as a public key). This may ensure that an mDL associated with a respective user cannot be transferred to multiple devices without authorization by the IA system (e.g., IA system 110A) and used in fraudulent transactions. Furthermore, associating an mDL with a particular user device (e.g., user device 108A) also enables the smart mobile wallet management system 102 and/or an IA system of an IA (e.g., IA system 110A) to verify that the intended user of the mDL is in possession of the mDL. Further still, associating an mDL with a particular user device (e.g., user device 108A) also ensures the safe transfer of sensitive credential data to and/or from the intended user of the mDL. In various examples, a user may store multiple copies of an mDL on multiple user devices (e.g., user devices 108A-108N). However, in such examples, each respective copy of the mDL may be cryptographically coupled to a respective user device by the IA system (e.g., IA system 110A) which provisioned the mDL. In this manner, each copy of the mDL can be independently verified against a respective user device to ensure that an mDL, or credential data associated with the mDL, cannot be transferred to unauthorized user devices.

An mDL may be associated with various mDL data security mechanisms used to ensure the validity of the mDL, authenticate an originating IA that issued the mDL, protect a user's personal data, and/or facilitate secure mDL-based transactions. In this regard, an mDL may be associated with a mobile security object (MSO) and/or various public and private cryptographic key information. An MSO is an electronically managed data structure that enables the authentication of the accuracy and origin of various credential data associated with the mDL during mDL-based transactions. In various examples, an MSO is associated with one or more portions of credential data related to the issue date, expiration date, user signature, and/or expected credential update time associated with the mDL. In various embodiments, the one or more portions of credential data associated with the MSO may be used to verify the validity and/or status of the mDL during various transactions. For example, if the credential data associated with the MSO indicates that the mDL is expired, the corresponding user may not be permitted to engage in one or more transactions using the mDL (e.g., one or more age-restricted purchase transactions).

Additionally, an mDL may be associated with various cryptographic key information (e.g., public/private key pair information) that may be utilized by the smart mobile wallet management system 102 to authenticate an originating IA that issued the mDL, verify one or more portions of credential data associated with an mDL, and/or facilitate various mDL-based transactions (e.g., retail purchase transactions, user authentication protocols, mDL data queries) for a user associated with the mDL. For example, an IA associated with a respective IA system 110A may be associated with a unique public key that may be utilized by the smart mobile wallet management system 102 to identify and/or authenticate the originating IA of a respective mDL. As such, in various examples, an mDL may be configured to store and/or point to the public key information associated with the IA from which the mDL was provisioned. Additional details related to the execution of various operations related to one or more mDLs associated with a user by the smart mobile wallet management system 102 will be described in greater detail herein with reference to FIGS. 2-8.

In some embodiments, the smart mobile wallet management system 102 further comprises and/or integrates with a storage device that comprises a distinct component from other components of the smart mobile wallet management system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Additionally or alternatively, the storage device may host the software executed to operate the smart mobile wallet management system 102. Additionally or alternatively, the storage device may store information relied upon during operation of the smart mobile wallet management system 102, such as various user data (e.g., user attribute data, user identification data), mDL data (e.g., cryptographic information, credential information), enterprise data (e.g., payment account data, user transaction data, product and/or service data), smart mobile wallet data (e.g., payment account data, payment card data, and/or the like associated with a user), distribution data, logistical data, legal data, software application framework data, etc.), and/or the like configured in various data formats to be utilized by the smart mobile wallet management system 102. In addition, the storage device may store control signals, device characteristics, and/or access credentials enabling interaction between the smart mobile wallet management system 102 and/or one or more of the enterprise computing devices 106A-106N or user devices 108A-108N.

In various embodiments, the one or more enterprise computing devices 106A-106N and/or the one or more user devices 108A-108N may be embodied by any computing devices known in the art. The one or more enterprise computing devices 106A-106N and/or the one or more user devices 108A-108N need not themselves be independent devices but may be peripheral devices communicatively coupled to other computing devices.

### Example Implementing Apparatuses

The smart mobile wallet management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 2-8. As illustrated in FIG. 2, the apparatus 200 may include processor 202, memory 204, communications hardware 206, mDL management circuitry 208, user authentication circuitry 210, and/or smart mobile wallet management circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application instance (e.g., a mobile application), dedicated client device, or the like. In some embodiments, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

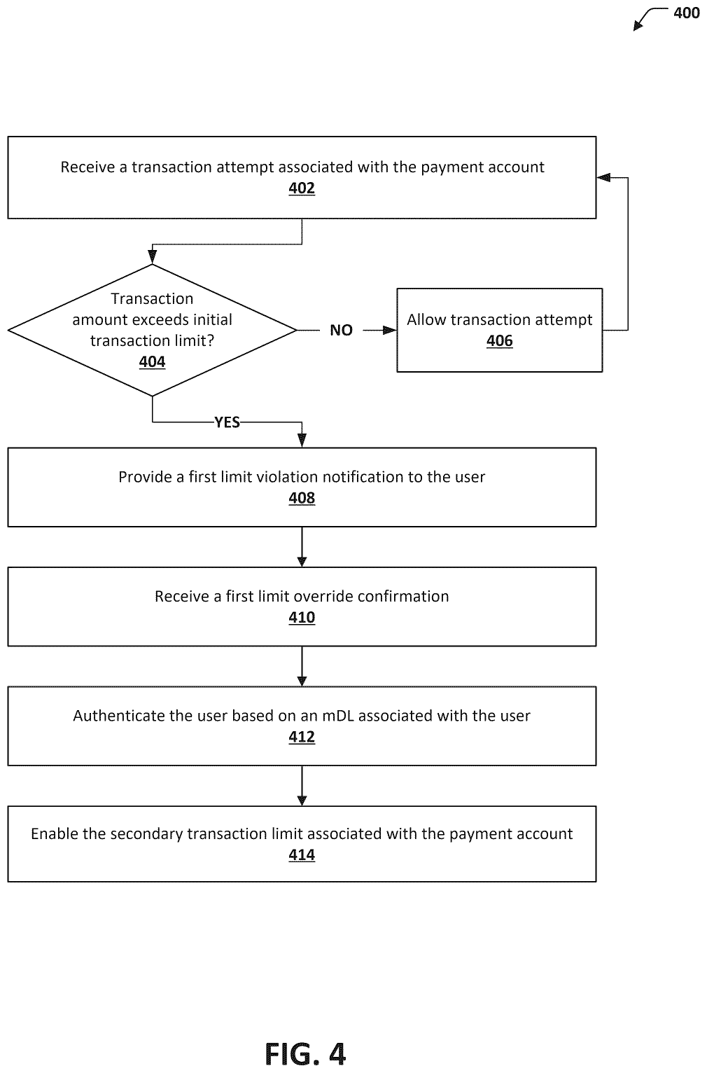

In addition, the apparatus 200 further comprises mDL management circuitry 208. In some embodiments, the mDL management circuitry 208 may be configured to facilitate the execution of one or more mDL authentication and/or IA authentication operations for an enterprise associated with the smart mobile wallet management system 102. Additionally, the mDL management circuitry 208 may utilize processor 202, memory 204, or any other hardware component included in the apparatus 200 to perform these operations, as described in connection with FIGS. 4-8 below. The mDL management circuitry 208 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the mDL management circuitry 208 may work in conjunction with the user authentication circuitry 210 and/or the smart mobile wallet management circuitry 212 in order to execute one or more of the methods described herein. For example, in some embodiments, the mDL management circuitry 208 may integrate with and/or otherwise leverage the user authentication circuitry 210 to facilitate the authentication of a user based on a respective mDL associated with the user.

In various circumstances, an IA system (e.g., IA system 110A) that previously issued an mDL to a respective user may periodically update credential data associated with the mDL (e.g., new user contact information, updated credential restrictions, updated credential endorsements). As such, the mDL management circuitry 208 may be configured to retrieve and/or receive updated credential data associated with a user's mDL from an IA system (e.g., IA system 110A) and facilitate the updating of the user's mDL based on the updated credential data. For example, if an mDL associated with a user is stored in a smart mobile wallet being managed by the smart mobile wallet management system 102, the mDL management circuitry 208 may be configured to receive updated credential data associated with the user's mDL from the originating IA system (e.g., IA system 110A) and subsequently update the user's mDL in the smart mobile wallet based on the updated credential data.

In some embodiments, the mDL management circuitry 208 may work in conjunction with the smart mobile wallet management circuitry 212 in order to update an mDL stored in a smart mobile wallet stored on a user device (e.g., user device 108A). In such embodiments, the mDL management circuitry 208 may be configured to query one or more storage devices (e.g., server systems) associated with an IA system (e.g., IA system 110A) in order to retrieve current and/or updated credential data in response to one or more interactions with a user interface associated with the smart mobile wallet. Additionally or alternatively, the mDL management circuitry 208 may be configured to periodically query to one or more storage devices (e.g., server systems) associated with an IA system (e.g., IA system 110A) based on a predefined schedule (e.g., once a day, once a week, once a month, once every 90 days) in order to retrieve current and/or updated credential data associated with a user' mDL.

In various examples, an IA (e.g., a branch of the DMV) associated with a respective IA system (e.g., IA system 110A) may enforce various mDL data freshness requirements associated with the mDLs the IA system provisions to users. In this regard, an MSO associated with a respective mDL may indicate a technical validity period associated with the mDL (e.g., a 30-day validity period). As such, the mDL management circuitry 208 may utilize the technical validity period indicated by the MSO to ensure that the credential data associated with the mDL stored on a user device (e.g., user device 108A) is updated and/or current. For example, if the mDL management circuitry 208 determines that the technical validity period indicated by the MSO has expired, the mDL may be invalidated until the credential data associated with the mDL is refreshed (e.g., updated, verified) by the IA system 110A associated with the IA from which the mDL was issued. In some examples, the technical validity period of the mDL indicated by the MSO may be shorter than a validity period of the mDL and/or the corresponding physical legal credential associated with the mDL (e.g., an expiration date of a driver's license associated with the mDL).

For example, legal credentials (e.g., a driver's license and/or the corresponding mDL) are commonly associated with a relatively long validity period (e.g., five to seven years from the date of issue of the legal credential). However, problems may arise if an IA assigns various credential restrictions (e.g., driving restrictions) and/or credential endorsements (e.g., weighted vehicle endorsements) to a particular user's legal credential, yet the user fails to have the legal credential (e.g., a corresponding physical credential) updated with said credential restrictions and/or credential endorsements. To address such problems, if the mDL management circuitry 208 determines that the technical validity period indicated by the MSO of the mDL has expired, the corresponding mDL may flag the mDL such that the mDL will fail various authentication protocols during an mDL-based transaction.

In this regard, the mDL management circuitry 208 may be configured to facilitate the resetting of the technical validity period indicated by the MSO of the mDL in conjunction with a corresponding IA system (e.g., IA system 110A). Additionally or alternatively, the mDL management circuitry 208 may be configured to facilitate the updating and/or verification of the credential data associated with an mDL stored on a user device (e.g., user device 108A) each time the technical validity period associated with the MSO of the mDL is reset. This mDL data security mechanism ensures that the credential data associated with a user's mDL is always accurate and up to date.

As described herein, an mDL may be associated with various cryptographic key information (e.g., public/private key pair information) that may be utilized by the smart mobile wallet management system 102 to authenticate an originating IA that issued the mDL, verify one or more portions of credential data associated with an mDL, and/or facilitate various mDL-based transactions (e.g., transaction limit override operations, retail purchase transactions, user authentication protocols, mDL data queries) for a user associated with the mDL. In this regard, the mDL management circuitry 208 may be configured to generate and/or transmit an IA authentication request comprising a public key associated with an IA to a corresponding IA system 110A in order to verify that a particular mDL was indeed provisioned by the IA associated with the IA system 110A.

In some examples, an mDL may only comprise (e.g., store, point to) identifying information related to a particular IA such that the mDL management circuitry 208 may be configured to first obtain a public key associated with the IA from a corresponding IA system 110A based on the identifying information. Once the public key information associated with the IA is obtained, the mDL management circuitry 208 may be configured to generate an IA authentication request comprising the public key of the IA and transmit the IA authentication request to the IA system 110A (e.g., via the communications network 104). As such, the mDL management circuitry 208 may be configured to receive, from an IA system (e.g., IA system 110A) and in response to the IA authentication request, one or more portions of data indicating whether the IA is a bona fide IA and/or whether the mDL indeed originated from the IA.

Once the mDL management circuitry 208 confirms the validity of the IA and/or confirms that a particular mDL associated with a user originated from the IA, the mDL management circuitry 208 may be configured to generate a digital token comprising cryptographic information (e.g., public key information) associated with the mDL and the user. Additionally, in some embodiments, the cryptographic information associated with the mDL and comprised in the digital token may be user device identification data by which a user device (e.g., user device 108A) of the respective user may be uniquely identified. In various examples, the mDL management circuitry 208 may generate and/or transmit the digital token to an IA system (e.g., IA system 110A) such that the IA system may decrypt the cryptographic information comprised in the digital token. In this manner, the IA system (e.g., IA system 110A) may authenticate (e.g., verify) one or more portions of credential data associated with the mDL and/or one or more portions of user device identification data associated with the user device (e.g., user device 108A). In this regard, the mDL management circuitry 208 may be configured to receive, from the IA system (e.g., IA system 110A) and in response to transmitting the digital token, one or more portions of data indicating whether the mDL and/or the user device (e.g., user device 108A) identified by the digital token is valid. Furthermore, in various examples, the mDL management circuitry 208 may be configured to receive, from the IA system (e.g., IA system 110A) and in response to transmitting the digital token, one or more portions of credential data associated with the mDL.

In some embodiments, the mDL management circuitry 208 may be configured to generate a digital token comprising cryptographic information (e.g., public key information) associated with an mDL and/or a user device (e.g., user device 108A) associated with a particular user in response to an mDL authentication request associated with the particular user. In some embodiments, the mDL authentication request may be a request to authenticate an mDL associated with the particular user and thereby authenticate the identity of the particular user for one or more mDL-based transactions. A respective mDL authentication request may comprise one or more of cryptographic information (e.g., public key information) associated with an mDL and/or a user device (e.g., user device 108A). Additionally or alternatively, a respective mDL authentication request may comprise one or more desired data elements (e.g., one or more desired portions of credential data) associated with the mDL, location data, user profile data, user account data, social media data, smart mobile wallet identification data, user device identification data, and/or the like associated with the particular user. In various examples, the mDL authentication request may be associated with a user associated with a payment account and may be comprised in, or triggered by, a limit override confirmation received by the smart mobile wallet management system 102.

In various examples, an mDL validity response received from an IA system (e.g., IA system 110A) based on a digital token generated by the mDL management circuitry 208 may comprise the entirety of the credential data associated with the mDL of the particular user. Additionally or alternatively, in various other examples, an mDL validity response received from an IA system (e.g., IA system 110A) based on a digital token generated by the mDL management circuitry 208 may comprise a verification of the desired credential data associated with the mDL that was indicated by an mDL authentication request. Additionally or alternatively, in various other examples, an mDL validity response received from an IA system (e.g., IA system 110A) based on a digital token generated by the mDL management circuitry 208 may comprise a verification of the user device identification data associated with the user device (e.g., user device 108A) of the particular user. For example, the mDL validity response may verify that the user device currently associated with the mDL is the same (e.g., intended) user device that the mDL was originally provisioned to. In this manner, the smart mobile wallet management system 102 may be configured to confirm the validity of the mDL data of an mDL associated with a particular user in order to authenticate the identity of the particular user. Additionally, this enables the smart mobile wallet management system 102 to confirm whether the intended user and/or user device (e.g., user device 108A) associated with the mDL is currently in possession of the mDL. These and other operations associated with the mDL management circuitry 208 will be described in further detail herein below with reference to FIGS. 4-8.

In addition, the apparatus 200 further comprises user authentication circuitry 210. In some embodiments, the user authentication circuitry 210 may be configured to facilitate the execution of one or more user authentication operations for an enterprise associated with the smart mobile wallet management system 102. Additionally, the user authentication circuitry 210 may utilize processor 202, memory 204, to perform these operations, as described in connection with FIGS. 4-8 below. The user authentication circuitry 210 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the user authentication circuitry 210 may work in conjunction with the mDL management circuitry 208 and/or the smart mobile wallet management circuitry 212 in order to execute one or more of the methods described herein. For example, in some embodiments, the user authentication circuitry 210 may integrate with and/or otherwise leverage the mDL management circuitry 208 to facilitate the identification and/or authentication of a user based on a respective mDL associated with the user.

Additionally, the user authentication circuitry 210 may be configured to identify a smart mobile wallet associated with a respective user. For example, the user authentication circuitry 210 may identify a smart mobile wallet associated with a user based on attribute data associated with the user. In some embodiments, user attribute data associated with a respective user may comprise user profile data, user account data, user contact data, social media data, location data, and/or smart mobile wallet identification data associated with the respective user. In various examples, once the user authentication circuitry 210 identifies a smart mobile wallet that is associated with the respective user, the user authentication circuitry 210 may be configured to generate a user identification data request based on user attribute data associated with the respective user. The user authentication circuitry 210 may be configured to leverage the communications hardware 206 to transmit the user identification data request to the smart mobile wallet ostensibly associated with the respective user. Furthermore, the user authentication circuitry 210 may be configured to leverage the communications hardware 206 to receive user identification data from the smart mobile wallet ostensibly associated with the respective user based on the user identification data request.

In various examples, the user identification data associated with a respective user comprises cryptographic information associated with one or more of an mDL and/or a user device (e.g., user device 108A) associated with the respective user. In some embodiments the cryptographic information associated with the mDL and/or the user device may be a public key of a public/private key pair, where the public key is provisioned to the respective user by an IA upon issuance of the mDL. Such cryptographic information may be utilized by the smart mobile wallet management system 102 and/or an IA system (e.g., IA system 110A) associated with the IA that provisioned the mDL to identify and/or authenticate the mDL, one or more portions of desired mDL credential data, and/or the user device associated with the respective user. In this regard, the user authentication circuitry 210 may be configured to verify that the smart wallet ostensibly associated with the respective user is indeed associated with the respective user and that the smart mobile wallet management circuitry 212 may safely transmit and/or receive data (e.g., payment account data, transaction data) to and/or from the smart mobile wallet associated with the respective user.

Additionally or alternatively, in some embodiments, the user authentication circuitry 210 may be configured to facilitate execution of secondary user authentication of a respective user in addition to authenticating the respective user based on a corresponding mDL. In this regard, the user authentication circuitry 210 may be configured to facilitate the execution of a second factor of authentication including one or more of facial recognition, voice recognition, and/or biometric authentication techniques (e.g., fingerprint recognition, retina recognition, iris recognition). For example, the user authentication circuitry 210 may be configured to prompt a respective user via a user device (e.g., user device 108A) to authenticate themselves via a second factor of authentication (e.g., biometric authentication based on fingerprint data) before allowing the respective user to access a smart mobile wallet managed by the smart mobile wallet management system 102. Additionally or alternatively, in various embodiments, the user authentication circuitry 210 may be configured to prompt a respective user via a user device (e.g., user device 108A) to authenticate themselves via a second factor of authentication (e.g., voice recognition) either prior to or subsequent to authenticating the respective user based on an mDL associated with the respective user.

Additionally or alternatively, in some embodiments, the user authentication circuitry 210 may be configured to employ one or more facial recognition techniques to authenticate a user during a secondary user authentication process. For example, user authentication circuitry 210 may be configured to authenticate a respective user by matching image data related to the respective user's face that is captured in real time, or near-real time, (e.g., via a camera of a user device 108A) to user portrait image data associated with an mDL related to the respective user. In this regard, the user authentication circuitry 210 may be configured to generate an image matching score based on matching the image data of the user's face captured in real time, or near-real time, to the user portrait image data associated with the user's mDL.

As such, the user authentication circuitry 210 may be configured to determine if an image matching score (e.g., a numerical value or the like) satisfies a respective image matching threshold (e.g., a numerical value or the like). The image matching score may satisfy the respective image matching threshold if the image matching score is greater than or equal to the respective image matching threshold (e.g., to within an error value of ±1%, ±5%, or any other number). In other examples, the image matching score (e.g., a numerical value or the like) may satisfy the respective image matching threshold (e.g., a numerical value or the like) if the image matching score is less than or equal to the respective image matching threshold (e.g., to within an error value of ±1%, ±5%, or any other number). In this manner, the user authentication circuitry 210 may facilitate secondary authentication techniques in order to authenticate a respective user before allowing the respective user to access a respective smart mobile wallet via a user device (e.g., user device 108A). These and other operations associated with the user authentication circuitry 210 will be described in further detail herein below with reference to FIGS. 4-8.

In addition, the apparatus 200 further comprises smart mobile wallet management circuitry 212. In some embodiments, the smart mobile wallet management circuitry 212 may be configured to facilitate the execution of one or more smart mobile wallet operations and/or transactions for an enterprise associated with the smart mobile wallet management system 102. Additionally, the smart mobile wallet management circuitry 212 may utilize processor 202, memory 204, to perform these operations, as described in connection with FIGS. 4-8 below. The smart mobile wallet management circuitry 212 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the smart mobile wallet management circuitry 212 may work in conjunction with the mDL management circuitry 208 and/or the user authentication circuitry 210 in order to execute one or more of the methods described herein.

For example, in some embodiments, the smart mobile wallet management circuitry 212 may integrate with and/or otherwise leverage the user authentication circuitry 210 to facilitate the identification and/or authentication of a user in order to generate and/or configure one or more of an initial transaction limit, a secondary transaction limit, and/or a temporary transaction override limit and update a payment account associated with a user to include one or more of the initial transaction limit, the secondary transaction limit, and/or the temporary transaction override limit. In various examples, the smart mobile wallet management circuitry 212 may be configured to generate an initial transaction limit and/or a secondary transaction limit in response to an account limitation configuration request received from a user device (e.g., user device 108A) associated with a user.

In some embodiments, the account limitation configuration request may be generated and/or received from the user device (e.g., user device 108A) based on a user interaction with a user interface corresponding to a smart mobile wallet being managed by the smart mobile wallet management system 102. Furthermore, the account limitation configuration request may comprise one or more account limitation configuration parameters indicated by the user that define how one or more of an initial transaction limit and/or a second transaction limit are to be configured and/or utilized. In various examples, the one or more account limitation configuration parameters may comprise one or more of a monetary value associated with the initial transaction limit, a monetary value associated with the secondary transaction limit, and/or one or more transaction alert parameters (e.g., transaction attempt alert preferences, limit violation notification delivery preferences, and/or the like). In some embodiments, the account limitation configuration parameters associated with the account limitation configuration request may be entered, selected, and/or otherwise indicated in whole or in part by the user via a user interface associated with a smart mobile wallet managed by the smart mobile wallet management system 102.

In some examples, in order to access a user interface to provide an account limitation configuration request, the user may be required to provide associated user credentials (e.g., password, personal identification number, biometric data, etc.) to login to an associated user account. In an instance in which the user is successfully authenticated using the provided user credentials, the user may then be allowed to proceed with the account limitation configuration request. The set of account limitation configuration parameters may comprise one or more of a monetary value associated with the initial transaction limit, a monetary value associated with the secondary transaction limit, and/or one or more transaction alert parameters (e.g., transaction attempt alert preferences, limit violation notification delivery preferences, and/or the like).

In some embodiments, the smart mobile wallet management circuitry 212 may be configured with default and/or static values for one or more account transaction limitation configuration parameters. As such, the smart mobile wallet management circuitry 212 may use these values in an instance in which a user does not provide a value for an account transaction limitation configuration parameter or if the account transaction limitation configuration parameter value cannot be selected by the user, such as for security reasons. Thus, the smart mobile wallet management circuitry 212 may generate an initial transaction limit and/or a second transaction limit that is compliant with one more governmental and/or institutional policies and/or regulations.

Additionally, in various examples, the smart mobile wallet management circuitry 212 may be configured to generate a temporary transaction override limit for a payment account in response to a temporary account limitation override configuration request received from a user device (e.g., user device 108A) associated with a user. In such examples, the temporary account limitation override configuration request may be a request to override one or more of the initial transaction limit or the secondary transaction limit associated with the payment account for a predetermined amount of time. In some examples, the temporary account limitation override configuration request may be generated and/or received from the user device (e.g., user device 108A) based on a user interaction with a user interface corresponding to a smart mobile wallet being managed by the smart mobile wallet management system 102.

Furthermore, the temporary account limitation override configuration request may comprise one or more temporary account limitation override configuration parameters configured (e.g., indicated, selected, and/or the like) via the interaction with the user interface corresponding to the smart mobile wallet. In various examples, the one or more temporary account limitation override configuration parameters may comprise one or more of a monetary value associated with a temporary transaction override limit, a temporary transaction override expiration date and/or time period, a temporary transaction geolocation restriction, a temporary merchant restriction, and/or one or more temporary transaction alert parameters (e.g., transaction attempt alert preferences, limit violation notification delivery preferences, and/or the like).

In this regard, the smart mobile wallet management circuitry 212 may be configured to leverage the processor 202, the memory 204, and/or the communications hardware 206 to generate, cause transmission of, and/or cause display of a plurality of interactive user interface elements on a user interface associated with a software application instance associated with the smart mobile wallet management system 102 on a user device 108A. The plurality of interactive user interface elements may be configured as one or more interactive text fields, buttons, selectable images, hyperlinks, radio buttons, sliders, embedded multimedia modules, charts, graphs, prompts, notifications, banners, instructions, and/or the like configured to initiate execution of one or more commands (e.g., executable software instructions) based on an interaction (e.g., user input) with the plurality of interactive user interface elements.

Additionally or alternatively, the smart mobile wallet management circuitry 212 may be configured to leverage the processor 202, the memory 204, and/or the communications hardware 206 to generate and/or configure (e.g., instantiate, update) a smart mobile wallet comprising one or more of a plurality of interactive user interface elements. The smart mobile wallet management circuitry 212 may generate a smart mobile wallet for a respective user based on one or more user attributes associated with the respective user and/or enterprise data corresponding to the respective user stored by the enterprise associated with the smart mobile wallet management system 102. Additionally, the smart mobile wallet management circuitry 212 may be configured to leverage the processor 202, the memory 204, and/or the communications hardware 206 to provide the smart mobile wallet to a user device (e.g., user device 108A) associated with the respective user such that the respective user is enabled to interact with and/or utilize the smart mobile wallet to execute various operations, transactions, and/or the like.

For example, based on one or more interactions with a respective smart mobile wallet, the smart mobile wallet management circuitry 212 may be configured to generate and/or configure an initial transaction limit, a secondary transaction limit, and/or a temporary transaction override limit associated with a payment account of a respective user (e.g., a bank account managed by a financial institute with which the user is a member). Additionally or alternatively, the smart mobile wallet management circuitry 212 may be configured to facilitate the configuration, reconfiguration, update and/or management of an initial transaction limit, a secondary transaction limit, a temporary transaction override limit, a payment account, a digital payment card, a physical payment card, and/or the like via a smart mobile wallet associated with the respective user. Additionally or alternatively, the smart mobile wallet management circuitry 212 may be configured to display various digital representations and/or data related to an initial transaction limit, a secondary transaction limit, a temporary transaction override limit, a payment account, a digital payment card, a physical payment card, and/or the like via a smart mobile wallet associated with the respective user.

Additionally, based on one or more interactions with a respective smart mobile wallet, the smart mobile wallet management circuitry 212 may be configured to facilitate one or more financial transactions for a respective user. The one or more financial transactions may involve the settlement of a payment (e.g., the withdrawal and transfer of funds) initiated by a respective user with a particular merchant (e.g., an online merchant, a brick-and-mortar retailer). In this regard, the smart mobile wallet management circuitry 212 may be configured to utilize account data (e.g., user account identifier information, user account routing information, and/or the like) associated with one or more means of payment (e.g., a payment card, payment account routing information) stored in and/or associated with a smart mobile wallet of a respective user to ensure an appropriate amount of funds is transferred from the respective user to the merchant.

In this regard, the smart mobile wallet management circuitry 212 may be configured to determine whether a payment account is linked to a smart mobile wallet associated with the user. In an instance in which the payment account is not linked to the smart mobile wallet, the smart mobile wallet management circuitry 212 may be configured to leverage the communications hardware 206 to receive, retrieve, and/or otherwise obtain payment account data associated with the payment account from a user device (e.g., user device 108A) associated with the user. In some examples, the payment account data may comprise one or more of an account identifier, card number, account number, card verification value (CVV), user account information (e.g., username, password), and/or the like. Once the payment account data is acquired, the smart mobile wallet management circuitry 212 may be configured to link the payment account to the smart mobile wallet such that one or more transaction attempts associated with the payment account may be facilitated via the smart mobile wallet. These and other operations associated with the smart mobile wallet management circuitry 212 will be described in further detail herein below with reference to FIGS. 4-8.

Although components 202-212 are described in part using functional language, it will be understood that the particular implementations necessarily include the use of particular hardware. It should also be understood that certain of these components 202-212 may include similar or common hardware. For example, the mDL management circuitry 208, the user authentication circuitry 210, and/or the smart mobile wallet management circuitry 212 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition, refer to software instructions that configure the hardware components of the apparatus 200 to perform the various functions described herein.

Although the mDL management circuitry 208, the user authentication circuitry 210, and/or the smart mobile wallet management circuitry 212 may leverage processor 202, memory 204, and/or communications hardware 206 as described above, it will be understood that any of the mDL management circuitry 208, the user authentication circuitry 210, and/or the smart mobile wallet management circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the mDL management circuitry 208, the user authentication circuitry 210, and/or the smart mobile wallet management circuitry 212 comprise particular machinery designed for performing the functions described herein in connection with such elements of apparatus 200.

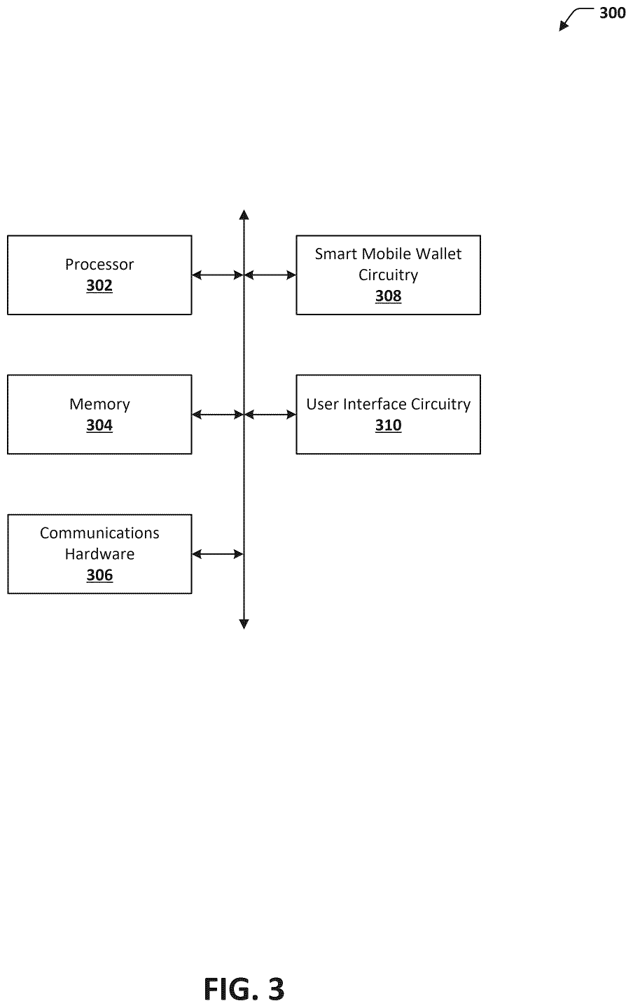

As illustrated in FIG. 3, an apparatus 300 is shown that represents an example enterprise computing device (e.g., any of enterprise computing devices 106A-106N) or an example user device (e.g., any of user devices 108A-108N). The apparatus 300 includes processor 302, memory 304, and communications hardware 306, each of which is configured to be similar to the similarly named components described above in connection with FIG. 2. Additionally, the apparatus 300 may also include smart mobile wallet circuitry 308, and/or user interface circuitry 310, each of which may be configured to facilitate the execution of the various methods described herein. For example, the smart mobile wallet circuitry 308, and/or the user interface circuitry 310 may be configured to work in conjunction to facilitate user interaction with the smart mobile wallet management system 102. Furthermore, the smart mobile wallet circuitry 308 may be configured to manage and/or facilitate one or more actions related to a smart mobile wallet associated with a respective user on a user device (e.g., user device 108A) that has been provisioned by the smart mobile wallet management system 102. In some embodiments, the smart mobile wallet circuitry 308 may utilize processor 302, memory 304, or any other hardware component included in the apparatus 300 to perform one or more of the operations described in connection with FIGS. 4-8 below.

In some embodiments, the smart mobile wallet circuitry 308 includes hardware components designed for generating one or more requests configured to initiate various operations to be executed by the smart mobile wallet management system 102. For example, the smart mobile wallet circuitry 308 may be configured to generate an account limitation configuration request and/or a temporary account limitation override configuration request for a user based on one or more interactions (e.g., user input, user selection) with a smart mobile wallet on a user device (e.g., user device 108A). As described herein, the account limitation configuration request and/or the temporary account limitation override configuration request may comprise a set of account limitation configuration parameters and/or temporary account limitation override configuration parameters respectively that are indicated by the user and define how an initial transaction limit, a secondary transaction limit, and/or a temporary transaction override limit are to be configured and/or utilized.

In some embodiments, the account limitation configuration parameters associated with the account limitation configuration request may be entered, selected, and/or otherwise indicated in whole or in part by the user (e.g., via a user interface associated with a smart mobile wallet). Additionally or alternatively, the account limitation configuration parameters associated with the account limitation configuration request may be automatically populated in whole or in part by the smart mobile wallet circuitry 308. Similarly, the temporary account limitation override configuration parameters associated with the temporary account limitation override configuration request may be entered, selected, and/or otherwise indicated in whole or in part by the user (e.g., via a user interface associated with a smart mobile wallet). Additionally or alternatively, the temporary account limitation override configuration parameters associated with the temporary account limitation override configuration request may be automatically populated in whole or in part by the smart mobile wallet circuitry 308.

In some embodiments, the account limitation configuration request and/or a temporary account limitation override configuration request may comprise one or more portions of user attribute data associated with a respective user. Furthermore, in some embodiments, the user attribute data may be entered, selected, and/or otherwise indicated in whole or in part by the user (e.g., via a user interface associated with a smart mobile wallet). Additionally or alternatively, the user attribute data associated may be automatically populated in whole or in part by the smart mobile wallet circuitry 308.

Additionally, in various examples, the smart mobile wallet circuitry 308 may be configured to generate responses to various queries transmitted to a smart mobile wallet on a respective user device (e.g., user device 108A). For instance, the smart mobile wallet circuitry 308 may be configured to generate and/or cause transmission of one or more limit override confirmations. For example, the communications hardware 306 may receive a limit violation notification from the smart mobile wallet management system 102 that indicates that a respective transaction attempt has exceeded (or may potentially exceed) a predetermined transaction limit associated with a particular payment account (e.g., an initial transaction limit, a second transaction limit, and/or a temporary transaction limit). As described herein, a limit violation notification may be configured to provoke (e.g., prompt, request, solicit) a user response and/or acknowledgement that a respective transaction limit has been exceeded. As such, the smart mobile wallet circuitry 308 may be configured to generate limit override confirmation that indicates a user's desire to actively exceed and/or override a predetermined transaction limit associated with a payment account (e.g., an initial transaction limit, a second transaction limit, and/or a temporary transaction limit).

In various examples, the first limit override confirmation may comprise an mDL and/or data associated with the mDL related to the user. For example, the first limit override confirmation may be generated based on a user interaction with a limit violation notification displayed via a smart mobile wallet associated with the user. In such examples, if the user interacts with the limit violation notification via a user interface associated with the smart mobile and indicates that they wish to override the initial transaction limit, the smart mobile wallet circuitry 308 of a user device (e.g., user device 108A) may be configured to generate a limit override confirmation comprising one or more portions of mDL data associated with the mDL of the user. As such, the first limit override confirmation may comprise one or more of cryptographic key information (e.g., public key information used to identify the mDL, a corresponding user device, and/or a corresponding user), originating IA data (e.g., cryptographic key information and/or identifying data associated with an originating IA), and/or other identifying data associated with the mDL of the user that is stored in the smart mobile wallet.

Furthermore, in various examples, a limit override confirmation may be configured to comprise and/or trigger the transmission and/or execution of one or more mDL authentication requests associated with a respective user associated with one or more of an initial transaction limit, a second transaction limit, and/or a temporary transaction limit. The one or more mDL authentication requests may be requests to verify and/or authenticate the respective user based on a corresponding mDL. For example, as described herein, the smart mobile wallet management system 102 may be configured to generate and/or transmit user identification data requests (e.g., user identification data requests, user identification data requests, and/or the like) to respective smart mobile wallets to facilitate the one or more operations described herein. As such, the smart mobile wallet circuitry 308 may be configured to generate and/or cause transmission of a response providing user identification data comprised in and/or associated with a smart mobile wallet on the user device (e.g., user device 108A).

As described herein, the user identification data associated with a respective user may comprise cryptographic information associated with one or more of an mDL and/or a user device (e.g., user device 108A) associated with the respective user. In some embodiments the cryptographic information associated with the mDL and/or the user device may be a public key of a public/private key pair, where the public key is provisioned to the respective user by an IA upon issuance of the mDL. Such cryptographic information may be utilized by the smart mobile wallet management system 102 and/or an IA system (e.g., IA system 110A) associated with the IA that provisioned the mDL to identify and/or authenticate the mDL, one or more portions of desired mDL credential data, and/or the user device associated with the respective user.

Additionally, the smart mobile wallet circuitry 308 may be configured to facilitate various actions associated with one or more payment methods associated with a smart mobile wallet on a respective user device (e.g., user device 108A). For example, the smart mobile wallet circuitry 308 may be configured to facilitate the management of, utilization of, and/or interaction with one or more of a payment card (e.g., a credit card, debit card), payment account (e.g., checking account, savings account), and/or user account affiliated with an enterprise (e.g., financial institution) associated with the smart mobile wallet management system 102. For instance, in some embodiments, the smart mobile wallet circuitry 308 may be configured to enable a user to check an account balance, view historical transactions, initiate a payment transaction, stop a payment transaction, transfer funds, link a payment account or method, unlink a payment account or method, settle a payment transaction at a POS associated with a merchant, settle an online payment transaction, and/or the like via the smart mobile wallet on a respective user device (e.g., user device 108A).

Furthermore, the smart mobile wallet circuitry 308 may be configured to facilitate various actions associated with an mDL of a respective user that is stored in and/or associated with the smart mobile wallet on a respective user device (e.g., user device 108A). For example, the smart mobile wallet circuitry 308 may be configured to cause an mDL to be updated, verified, authenticated and/or deleted from the smart mobile wallet. In some embodiments, the smart mobile wallet circuitry 308 may be configured to leverage the communications hardware 306 to communicate with an IA system (e.g., IA system 110A) in order to retrieve and/or receive one or more portions of mDL data (e.g., updated credential data) associated with an mDL stored in the smart mobile wallet. Additionally or alternatively, the smart mobile wallet circuitry 308 may be configured to leverage the communications hardware 306 to cause one or more components of the apparatus 200 (e.g., the mDL management circuitry 208) to facilitate the update of an mDL stored in a smart mobile wallet of a respective user device (e.g., user device 108A).

In addition, the apparatus 300 may also include the user interface circuitry 310, which includes hardware components designed for receiving user inputs and/or rendering virtual graphics outputs. The user interface circuitry 310 may utilize processor 302, memory 304, or any other hardware component included in, or integrated with, the apparatus 300 to perform these operations, as described in connection with FIGS. 4-8 below. The user interface circuitry 310 may further utilize communications hardware 306 to transmit data representative of a user input and/or receive data to render as a virtual graphics output or may otherwise utilize processor 302 and/or memory 304 to generate data representative of a user input and/or generate virtual graphics output, e.g., from based on received data. The user interface circuitry 310 may comprise one or more of a keyboard, pointing device, touchscreen, microphone with speech recognition interface, one or more cameras, and/or one or more other input devices capable of receiving various different user inputs. In addition, the user interface circuitry 310 may comprise a display device including one or more of a screen with graphical user interface (GUI), speaker, light-emitting diode (LED) display, organic LED (OLED) display, LCD display, touchscreen, haptic technology device, and/or other output device capable of rendering information to a user.

Additionally, the user interface circuitry 310 may utilize processor 302, memory 304, smart mobile wallet circuitry 308, or any other hardware component included in, or integrated with, the apparatus 300 to run, host, configure, and/or otherwise execute one or more operations, instructions, and/or commands related to a software application instance and/or smart mobile wallet associated with the smart mobile wallet management system 102. For example, the user interface circuitry 310 may be configured allow a user to interact with the smart mobile wallet management system 102 via the software application instance in order to facilitate one or more transaction limit configuration operations, smart mobile wallet operations, user authentication operations, and/or any of the other methods described herein.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200, or 300, may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Operations

Turning to FIGS. 4-7, example flowcharts are illustrated that contain example operations implemented by example embodiments described herein. The operations illustrated in FIGS. 4-7 may, for example, be performed by a system device (e.g., server, etc.) of the smart mobile wallet management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, mDL management circuitry 208, user authentication circuitry 210, smart mobile wallet management circuitry 212, and/or any combination thereof. It will be understood that user interaction with the smart mobile wallet management system 102 may occur directly via communications hardware 206, or may instead be facilitated by a separate computing device (e.g., any of enterprise computing devices 106A-106N, and/or user devices 108A-108N shown in FIG. 1, which may in turn be embodied by an apparatus 300, which is shown and described in connection with FIG. 3), and which may have similar or equivalent physical componentry facilitating such user interaction.

Turning first to FIG. 4, flowchart 400 illustrates example operations for providing account transaction control and management for one or more payment accounts associated with a user.

As shown by operation 402, the apparatus 200 may include means, such as processor 202, memory 204, communications hardware 206, and/or the like for receiving a transaction attempt associated with a payment account, where the payment account includes an initial transaction limit and/or a secondary transaction limit. In various examples, a transaction attempt may be an attempt to purchase goods and/or services using funds associated with the payment account and may executed in-person (e.g., via POS terminal at a physical retail location) or remotely via a communications network 104 (e.g., via a website, mobile application, and/or the like). A transaction attempt may be associated with various data including, but not limited to, a transaction amount (e.g., a monetary value associated with one or more goods and/or services), a payment method (e.g., data related to a payment account, payment card, and/or the like), a merchant identifier, a POS location (e.g., a merchant location, a user location and/or the like indicated by GPS coordinates), a description of one or more goods and/or services being purchased, and/or the like.

As described herein, the smart mobile wallet management circuitry 212 may be configured to generate and provide a software application instance associated with the smart mobile wallet management system 102 to a user device (e.g., user device 108A) where the software application instance may be configured to enable a user to access a smart mobile wallet configured to manage one or more respective payment accounts, payment cards, mDLs, and/or the like. For example, as described herein, a user may utilize the software application instance associated with the smart mobile wallet management system 102 to configure, modify, update, and/or otherwise manage one or more payment account preferences including setting or updating a monetary value and/or time period associated with one or more of an initial transaction limit, a secondary transaction limit, and/or a temporary transaction override limit corresponding to a respective payment account.

As such, once one or more transaction limits (e.g., initial transaction limits, secondary transaction limits) are generated and/or enabled for one or more payment methods (e.g., payment accounts, payment cards, and/or the like) comprised in a smart mobile wallet associated with the user, the user may utilize the payment methods in an expected manner. In this regard, the communications hardware 206 may be configured to receive a transaction attempt associated with the payment account configured with one or more transaction limits (e.g., an initial transaction limit, secondary transaction limit, and/or the like), where the transaction attempt is generated based on a user interaction with a smart mobile wallet.

As shown by operation 404, the apparatus 200 may include means, such as processor 202, memory 204, smart mobile wallet management circuitry 212, and/or the like for determining whether a transaction amount associated with the transaction attempt exceeds an initial transaction limit associated with the payment account. In various examples, the smart mobile wallet management circuitry 212 may be configured to compare a transaction amount associated with the transaction attempt to one or more transaction limits (e.g., one or more of an initial transaction limit, a secondary transaction limit, and/or a temporary transaction override limit).

As described herein, the initial transaction limit and/or the secondary transaction limit may be associated with different respective monetary values. In various examples, an initial transaction limit may be a first transaction limit enforced by the smart mobile wallet management system 102 and may have a lower monetary value relative to that of a secondary transaction limit. As such, a secondary transaction limit may be a second transaction limit enforced by the smart mobile wallet management system 102 and may have a higher monetary value relative to that of an initial transaction limit. As a non-limiting example, an initial transaction limit may be associated with a monetary value of $200 and a secondary transaction limit may be associated with a monetary value of $500 for a given payment account.

Furthermore, an initial transaction limit may be associated with a predetermined time period (e.g., daily, weekly, monthly, bi-monthly, and/or the like). For example, if an initial transaction limit (e.g., $150, or any other amount) is associated with a daily time period (e.g., 12:00 AM-11:59 PM), one or more transactions executed during a respective day may be totaled by the smart mobile wallet management circuitry 212 to determine if the initial transaction limit has been exceeded for that respective day. Similarly, as another example, if an initial transaction limit (e.g., $800, or any other amount) is associated with a weekly time period (e.g., a seven-day time period), one or more transactions executed during a calendar week may be totaled by the smart mobile wallet management circuitry 212 to determine if the initial transaction limit has been exceeded for that calendar week. As such, in some circumstances, a single transaction attempt may be associated with a transaction amount that exceeds an initial transaction limit. Alternatively, in other circumstances, a series of transaction attempts may be associated with a cumulative transaction amount that exceeds an initial transaction limit within a corresponding time period (e.g., a weekly time period).

In this regard, if the smart mobile wallet management circuitry 212 determines that the transaction amount associated with the transaction attempt does not exceed the initial transaction limit, the smart mobile wallet management circuitry 212 may be configured to proceed to operation 406. Alternatively, if the smart mobile wallet management circuitry 212 determines that the transaction amount associated with the transaction attempt exceeds the initial transaction limit, the smart mobile wallet management circuitry 212 may be configured to proceed to operation 408.

As shown by operation 406, the apparatus 200 may include means, such as processor 202, memory 204, smart mobile wallet management circuitry 212, and/or the like for allowing the transaction attempt. For example, the smart mobile wallet management circuitry 212 may be configured to allow a transaction attempt upon determining that the transaction attempt does not exceed the initial transaction limit associated with the payment account. In various examples, allowing a transaction attempt may comprise causing, initiating, permitting, and/or otherwise facilitating a transfer of an agreed-upon amount of currency equal to the transaction amount (e.g., a monetary amount associated with one or more good and/or services) of the transaction attempt from the payment account associated with the user (e.g., the payment account associated with the initial transaction limit) to a second payment account associated with a third-party merchant.

As shown by operation 408, the apparatus 200 may include means, such as processor 202, memory 204, communications hardware 206, smart mobile wallet management circuitry 212, and/or the like for providing a first limit violation notification to the user. For example, the smart mobile wallet management circuitry 212 may be configured to generate one or more limit violation notifications and leverage the communications hardware 206 to provide the one or more limit violation notifications to one or more computing devices (e.g., one or more of the user devices 108A-108N, enterprise computing devices 106A-106N, and/or the like). In some examples, a limit violation notification indicates that a transaction attempt has exceeded a respective transaction limit (e.g., an initial transaction limit, secondary transaction limit, and/or temporary transaction override limit). A limit violation notification may further comprise data related to the transaction attempt that exceeded the respective transaction limit such as a transaction amount (e.g., a monetary value associated with one or more goods and/or services), a payment method (e.g., data related to a payment account, payment card, and/or the like), a merchant identifier, a POS location (e.g., a merchant location, a user location and/or the like indicated by GPS coordinates), a description of one or more goods and/or services being purchased, and/or the like. Furthermore, the limit violation notification may indicate the predetermined monetary value of the transaction limit (e.g., the initial transaction limit) that was violated to remind the user of the predetermined monetary value associated with the transaction limit.

In various examples, the smart mobile wallet management circuitry 212 may be configured to generate a first limit violation notification in a variety of formats including, but not limited to, an email, an SMS message (e.g., a text message), a smart mobile wallet notification, an automated telephone message, and/or any other suitable format. In this regard, the smart mobile wallet management circuitry 212 may be configured to retrieve various contact information (e.g., email addresses, phone numbers, computing device addresses, and/or the like) related to one or more of the user, an enterprise representative, and/or any other relevant entity (e.g., data security personnel) and provide a respective limit violation notification to one or more computing devices associated with the user, the enterprise representative, and/or any other relevant entity (e.g., data security personnel) based on the various contact information.

For example, the smart mobile wallet management circuitry 212 may be configured to identify a smart mobile wallet associated with the user and provide the first limit violation notifications to the smart mobile wallet such that the user is made aware that a transaction attempt they have executed has violated the initial transaction limit associated with a particular payment account. In various examples, this operation may happen in real time or near-real time such that the first limit violation notification is provided to the smart mobile wallet at a same or similar time that the transaction attempt is executed. In such examples, the first limit violation notification may be configured as an interactive prompt comprising one or more interactive user interface elements (e.g., buttons, hyperlinks, and/or the like) configured to enable the user to acknowledge and/or respond to the first limit violation notification.

In some examples, the smart mobile wallet management circuitry 212 may be configured to identify a POS terminal associated with the transaction attempt and, if the POS terminal is networked (e.g., via the communications network 104) and/or configured to receive and/or display messages, the smart mobile wallet management circuitry 212 may be configured to cause display of the first limit violation notification via the POS terminal. Additionally, in some examples, the first limit violation notification displayed on the POS terminal may be interactive such that the use may indicate (e.g., by interacting with one or more interactive user interface elements) that they wish to override the initial transaction limit and continue with the transaction attempt via the POS terminal. Furthermore, in some examples, the smart mobile wallet management circuitry 212 may be configured to leverage the communications hardware 206 to provide the first limit violation notification via two or more methods and/or in two or more formats. For example, the smart mobile wallet management circuitry 212 may be configured to provide the first limit violation notification to the smart mobile wallet associated with the user and simultaneously provide the first limit violation notification to the POS terminal associated with the transaction attempt such that the user receives the first limit violation notification in multiple ways and in multiple respective formats.

As shown by operation 410, the apparatus 200 may include means, such as processor 202, memory 204, communications hardware 206, smart mobile wallet management circuitry 212 and/or the like for receiving a first limit override confirmation from a user device (e.g., user device 108A) associated with the user. In various examples, the communications hardware 206 may be configured to receive a first limit override confirmation from the user device (e.g., user device 108A) associated with the user in response to a first limit violation notification that was provided to the user and/or the user device (e.g., to a smart mobile wallet associated with the user and/or user device). The first limit override confirmation may be an indication that the user desires to override a first transaction limit (e.g., the initial transaction limit) and activate (e.g., enable) a different transaction limit (e.g., a secondary transaction) associated with the corresponding payment account. Alternatively, in other examples, the first limit override confirmation may indicate that a user does not desire to override the first transaction limit. In such examples, if the first limit override confirmation indicates that the user does not wish to override the first transaction limit, the smart mobile wallet management circuitry 212 may be configured to deny the corresponding transaction attempt.

In some examples, the first limit override confirmation may be generated in response to an interaction with the first limit violation notification. For example, the first limit override confirmation may be generated in response to a user interaction with the first limit violation notification configured as an interactive prompt and provided to a smart mobile wallet associated with the user. Additionally or alternatively, in some embodiments, the first limit override confirmation may be configured in a variety of other formats. For example, the first limit override confirmation may be configured as an email, a verbal confirmation (e.g., by the user to an enterprise representative), and/or a direct message (e.g., SMS message, virtual chat message, and/or the like) generated in response to the first limit violation notification.

Additionally, in various examples, the first limit override confirmation may comprise an mDL and/or data associated with the mDL related to the user. For example, the first limit override confirmation may be generated based on a user interaction with the first limit violation notification displayed via a smart mobile wallet associated with the user. In such examples, if the user interacts with the first limit violation notification via a user interface associated with the smart mobile and indicates that they wish to override the first transaction limit (e.g., the initial transaction limit), the smart mobile wallet circuitry 308 of a user device (e.g., user device 108A) may be configured to generate the first limit override confirmation comprising one or more portions of mDL data associated with the mDL of the user. As such, the first limit override confirmation may comprise one or more of cryptographic key information (e.g., public key information used to identify the mDL, a corresponding user device, and/or a corresponding user), originating IA data (e.g., cryptographic key information and/or identifying data associated with an originating IA), and/or other identifying data associated with the mDL of the user that is stored in the smart mobile wallet.

As shown by operation 412, the apparatus 200 may include means, such as processor 202, memory 204, communications hardware 206, mDL management circuitry 208, user authentication circuitry 210, smart mobile wallet management circuitry 212, and/or the like for authenticating the user based on the mDL associated with the user. For example, the user authentication circuitry 210 may be configured to leverage one or more of the communications hardware 206, the mDL management circuitry 208, and/or the smart mobile wallet management circuitry 212 to authenticate the user in response to receiving the first limit override confirmation from the user device (e.g., user device 108A) associated with the user.

Accordingly, the user authentication circuitry 210 may be configured to execute an mDL authentication request associated with the user. The mDL authentication request is a request to authenticate the mDL stored in the smart mobile wallet associated with the user. In some embodiments, the mDL authentication request may be initiated, triggered, and/or executed based on the first limit override confirmation received from the user device (e.g., user device 108A) associated with the user. In some embodiments, the user authentication circuitry 210 may be configured to facilitate the execution of the mDL authentication request based on or more data features associated with the mDL authentication request. For example, in some embodiments, the mDL authentication request may comprise one or more of user identification data (e.g., cryptographic information associated with an mDL and/or a user device) associated with the user, desired credential data associated with the mDL (e.g., a particular request may indicate a need for verification of particular user information or PII of the user, particular credential validity data, and/or the like), and/or user attribute data associated with the user.

In some examples, the mDL management circuitry 208 may be configured to generate a digital token based in part on the mDL authentication request. For example, the mDL management circuitry 208 may be configured to generate a digital token comprising cryptographic information (e.g., public key information) associated with the mDL of the user. Additionally, in some examples, the cryptographic information associated with the mDL and comprised in the digital token may be user device identification data by which a user device (e.g., user device 108A) of the user may be uniquely identified.

Furthermore, the mDL management circuitry 208 may be configured to leverage the communications hardware 206 to transmit the digital token to an IA system (e.g., IA system 110A) associated with the IA that provisioned the mDL to the user such that the IA system (e.g., IA system 110A) may decrypt the cryptographic information comprised in the digital token. In this manner, the IA system (e.g., IA system 110A) may authenticate (e.g., verify) one or more portions of credential data associated with the mDL and/or one or more portions of user device identification data associated with the user device (e.g., user device 108A) of the user.

Furthermore, in various examples, the communications hardware 206 may receive an mDL validity response from the IA system (e.g., IA system 110A) associated with the IA that provisioned the mDL to the user. In various embodiments, the mDL validity response is generated based on the digital token associated with the user. In some examples, the mDL validity response indicates verified credential data (e.g., desired credential data) associated with the mDL indicated by the mDL authentication request. Furthermore, in some examples, the mDL validity response may also indicate verified user device identification data related to the user device associated with the user (e.g., user device 108A). In this regard, the user authentication circuitry 210 may be configured to authenticate the user based on the data comprised in the mDL validity response received from the IA system (e.g., one of IA systems 110A-110N). In this manner, the smart mobile wallet management system 102 may be configured to determine whether the user has been successfully authenticated based on the mDL validity response received based on the execution of the mDL authentication request associated with the user.

In some examples, if the user authentication circuitry 210 determines that the user has not been successfully authenticated, the user authentication circuitry 210 may be configured to generate an authentication alert. In various embodiments, the authentication alert may be an alert, notification, warning, advisory, and/or the like that indicates various data related to a failed user authentication attempt related to a user. The authentication alert may comprise data related to a user that was not successfully authenticated including, but not limited to, user contact information, user account information, credential data (e.g., mDL data), user device identification data, timestamp data associated with the user authentication attempt, geolocation data associated with the user during a time in which the user authentication attempt was executed (e.g., as indicated by GPS data collected and/or generated by a user device), and/or enterprise data (e.g., software application instance data, payment account data, user transaction data, product and/or service data, and/or the like associated with an enterprise utilizing the smart mobile wallet management system 102).

In various examples, an authentication alert may be configured as a notification, email, text message, direct application message (e.g., via a software application instance associated with the smart mobile wallet management system 102), audio message (e.g., automated voice message), banner notification, and/or the like. The user authentication circuitry 210 may be configured to leverage the communications hardware 206 to transmit an authentication alert to one or more computing devices (e.g., one or more enterprise computing device 106A-106N, user devices 108A-108B, IA systems (110A-110N), and/or the like via a number of different communication methods over a communications network (e.g., communications network 104).

In this regard, the user authentication circuitry 210 may be configured to identify one or more individuals and/or one or more computing devices associated with said individuals to transmit the authentication alert to. For example, the user authentication circuitry 210 may be configured to identify one or more enterprise representatives associated with one or more respective enterprise computing device 106A-106N and cause transmission of an authentication alert to the one or more respective enterprise computing device 106A-106N. Additionally or alternatively, in the event that a user was not successfully identified, the user authentication circuitry 210 may be configured to cause transmission of an authentication alert to a user device (e.g., user devices 108A-108N).

As shown by operation 414, the apparatus 200 may include means, such as processor 202, memory 204, smart mobile wallet management circuitry 212, and/or the like for enabling the secondary limit associated with the payment account. For example, the smart mobile wallet management circuitry 212 may be configured to activate, enable, and/or otherwise initiate the use of the secondary transaction limit for the payment account. In some examples, the smart mobile wallet management circuitry 212 is configured to enable the secondary transaction limit in response to a determination that the user has been successfully authenticated based on the user's mDL. As such, once the secondary transaction limit is enabled for the payment account, the user may be permitted to make one or more transactions totaling a monetary amount less than or equal to the monetary value associated with the secondary transaction limit (e.g., $800, or any other predetermined amount).

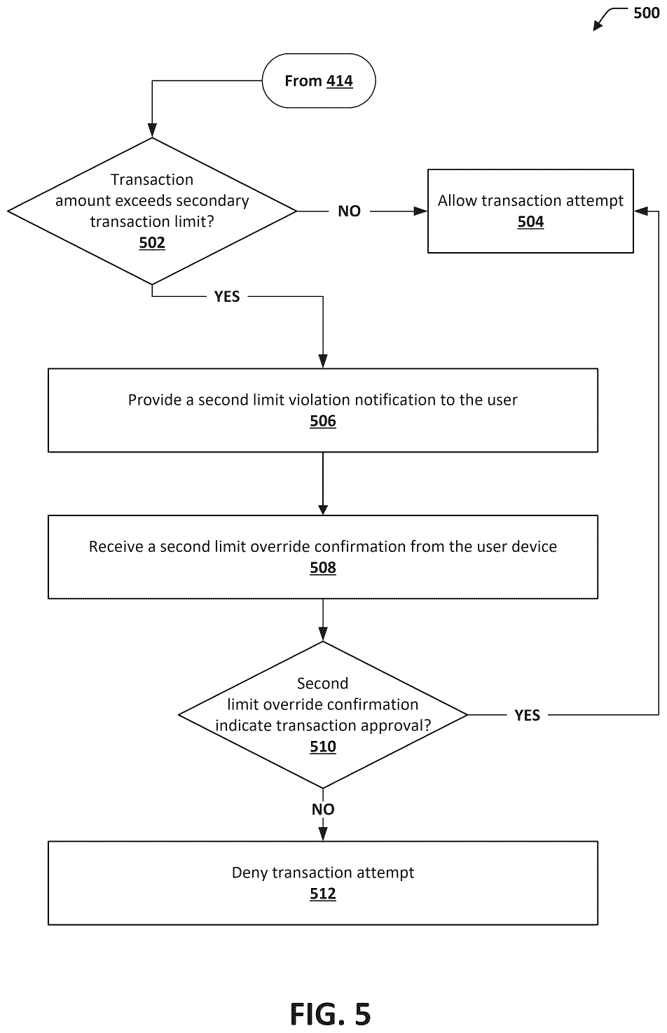

Turning now to FIG. 5, flowchart 500 illustrates example operations for allowing or denying a respective transaction attempt according to various aspects described herein. In some examples, one or more of the operations associated with the flowchart 500 are performed concurrently with one or more operations described with reference to FIG. 4. Alternatively, in other examples, the operations associated with the flowchart 500 may be performed in response to the execution of one or more operations described with reference to FIG. 4. For example, the operations described by the flowchart 500 may be performed subsequent to, or in response to, the execution of operation 414 described with reference to FIG. 4 in which the secondary transaction limit is enabled. Alternatively, as another example, one or more of the operations described by the flowchart 500 may be performed subsequent to, or in response to, the execution of operation 404 described herein with reference to FIG. 4 in which it is determined whether a transaction amount exceeds an initial transaction limit. For purposes of explanation and not of limitation, the operations associated with the flowchart 500 will be described herein as a series of operations to be executed subsequent to the execution of operation 414 described with reference to FIG. 4.

As shown by operation 502, the apparatus 200 may include means, such as processor 202, memory 204, smart mobile wallet management circuitry 212, and/or the like for determining whether the transaction amount of the transaction attempt exceeds the secondary transaction limit associated with the payment account. As described herein, the smart mobile wallet management circuitry 212 may be configured to compare a transaction amount associated with the transaction attempt to one or more transaction limits (e.g., one or more of an initial transaction limit, a secondary transaction limit, and/or a temporary transaction override limit). In this regard, if the smart mobile wallet management circuitry 212 determines that the transaction amount associated with the transaction attempt does not exceed the secondary transaction limit, the smart mobile wallet management circuitry 212 may be configured to proceed to operation 504. Alternatively, if the smart mobile wallet management circuitry 212 determines that the transaction amount associated with the transaction attempt exceeds the secondary transaction limit, the smart mobile wallet management circuitry 212 may be configured to proceed to operation 506.

As shown by operation 504, the apparatus 200 may include means, such as processor 202, memory 204, smart mobile wallet management circuitry 212, and/or the like for allowing the transaction attempt. For example, the smart mobile wallet management circuitry 212 may be configured to allow a transaction attempt upon determining that the transaction attempt does not exceed the secondary transaction limit associated with the payment account. As described herein, allowing a transaction attempt may comprise causing, initiating, permitting, and/or otherwise facilitating a transfer of an agreed-upon amount of currency equal to the transaction amount (e.g., a monetary amount associated with one or more good and/or services) of the transaction attempt from the payment account associated with the user (e.g., the payment account associated with the secondary transaction limit) to a second payment account associated with a third-party merchant.

As shown by operation 506, the apparatus 200 may include means, such as processor 202, memory 204, communications hardware 206, smart mobile wallet management circuitry 212, and/or the like for providing a second limit violation notification to the user. For example, as described herein, the smart mobile wallet management circuitry 212 may be configured to generate one or more limit violation notifications and leverage the communications hardware 206 to provide the one or more limit violation notifications to one or more computing devices (e.g., one or more of the user devices 108A-108N, enterprise computing devices 106A-106N, and/or the like). In some examples, a limit violation notification indicates that a transaction attempt has exceeded a respective transaction limit (e.g., an initial transaction limit, secondary transaction limit, and/or temporary transaction override limit). A limit violation notification may further comprise data related to the transaction attempt that exceeded the respective transaction limit such as a transaction amount (e.g., a monetary value associated with one or more goods and/or services), a payment method (e.g., data related to a payment account, payment card, and/or the like), a merchant identifier, a POS location (e.g., a merchant location, a user location and/or the like indicated by GPS coordinates), a description of one or more goods and/or services being purchased, and/or the like. Furthermore, the limit violation notification may indicate the predetermined monetary value of the transaction limit (e.g., the initial transaction limit) that was violated to remind the user of the predetermined monetary value associated with the transaction limit.

In various examples, the smart mobile wallet management circuitry 212 may be configured to generate a second limit violation notification in a variety of formats including, but not limited to, an email, an SMS message (e.g., a text message), a smart mobile wallet notification, an automated telephone message, and/or any other suitable format. In this regard, the smart mobile wallet management circuitry 212 may be configured to retrieve various contact information (e.g., email addresses, phone numbers, computing device addresses, and/or the like) related to one or more of the user, an enterprise representative, and/or any other relevant entity (e.g., data security personnel) and provide a respective limit violation notification to one or more computing devices associated with the user, the enterprise representative, and/or any other relevant entity (e.g., data security personnel) based on the various contact information.

For example, the smart mobile wallet management circuitry 212 may be configured to identify a smart mobile wallet associated with the user and provide the second limit violation notifications to the smart mobile wallet such that the user is made aware that a transaction attempt they have executed has violated the initial transaction limit associated with a particular payment account. In various examples, this operation may happen in real time or near-real time such that the second limit violation notification is provided to the smart mobile wallet at a same or similar time that the transaction attempt is executed. In such examples, the second limit violation notification may be configured as an interactive prompt comprising one or more interactive user interface elements (e.g., buttons, hyperlinks, and/or the like) configured to enable the user to acknowledge and/or respond to the second limit violation notification.

In some examples, the smart mobile wallet management circuitry 212 may be configured to identify a POS terminal associated with the transaction attempt and, if the POS terminal is networked (e.g., via the communications network 104) and/or configured to receive and/or display messages, the smart mobile wallet management circuitry 212 may be configured to cause display of the second limit violation notification via the POS terminal. Additionally, in some examples, the second limit violation notification displayed on the POS terminal may be interactive such that the use may indicate (e.g., by interacting with one or more interactive user interface elements) that they wish to override the initial transaction limit and continue with the transaction attempt via the POS terminal. Furthermore, in some examples, the smart mobile wallet management circuitry 212 may be configured to leverage the communications hardware 206 to provide the second limit violation notification via two or more methods and/or in two or more formats. For example, the smart mobile wallet management circuitry 212 may be configured to provide the second limit violation notification to the smart mobile wallet associated with the user and simultaneously provide the second limit violation notification to the POS terminal associated with the transaction attempt such that the user receives the second limit violation notification in multiple ways and in multiple respective formats.

As shown by operation 508, the apparatus 200 may include means, such as processor 202, memory 204, communications hardware 206, smart mobile wallet management circuitry 212 and/or the like for receiving a second limit override confirmation from a user device (e.g., user device 108A) associated with the user. In various examples, the communications hardware 206 may be configured to receive a second limit override confirmation from the user device (e.g., user device 108A) associated with the user in response to a second limit violation notification that was provided to the user and/or the user device (e.g., to a smart mobile wallet associated with the user and/or user device). The second limit override confirmation may be an indication that the user desires to override a second transaction limit (e.g., the secondary transaction limit) associated with the corresponding payment account. Alternatively, in other examples, the second limit override confirmation may indicate that a user does not desire to override the second transaction limit. In such examples, if the second limit override confirmation indicates that the user does not wish to override the second transaction limit, the smart mobile wallet management circuitry 212 may be configured to deny the corresponding transaction attempt.

In some examples, the second limit override confirmation may be generated in response to an interaction with the second limit violation notification. For example, the second limit override confirmation may be generated in response to a user interaction with the second limit violation notification configured as an interactive prompt and provided to a smart mobile wallet associated with the user. Additionally or alternatively, in some embodiments, the second limit override confirmation may be configured in a variety of other formats. For example, the second limit override confirmation may be configured as an email, a verbal confirmation (e.g., by the user to an enterprise representative), and/or a direct message (e.g., SMS message, virtual chat message, and/or the like) generated in response to the second limit violation notification.

Additionally, in various examples, the second limit override confirmation may comprise an mDL and/or data associated with the mDL related to the user. For example, the second limit override confirmation may be generated based on a user interaction with the second limit violation notification displayed via a smart mobile wallet associated with the user. In such examples, if the user interacts with the second limit violation notification via a user interface associated with the smart mobile and indicates that they wish to override the second transaction limit (e.g., the secondary transaction limit), the smart mobile wallet circuitry 308 of a user device (e.g., user device 108A) may be configured to generate the second limit override confirmation comprising one or more portions of mDL data associated with the mDL of the user. As such, the second limit override confirmation may comprise one or more of cryptographic key information (e.g., public key information used to identify the mDL, a corresponding user device, and/or a corresponding user), originating IA data (e.g., cryptographic key information and/or identifying data associated with an originating IA), and/or other identifying data associated with the mDL of the user that is stored in the smart mobile wallet.

As shown by operation 510, the apparatus 200 may include means, such as processor 202, memory 204, user authentication circuitry 210, smart mobile wallet management circuitry 212, and/or the like for determining whether the second limit override confirmation indicates user approval of the transaction attempt and/or the user's desire to override the second transaction limit (e.g., the secondary transaction limit). For example, the smart mobile wallet management circuitry 212 may be configured to parse the second limit override confirmation to determine whether to allow or deny the transaction attempt.

As such, in some examples, the user authentication circuitry 210 may be configured to leverage one or more of the communications hardware 206, the mDL management circuitry 208, and/or the smart mobile wallet management circuitry 212 to authenticate (or re-authenticate) the user in response to receiving the second limit override confirmation from the user device (e.g., user device 108A) associated with the user. In such examples, the user authentication circuitry 210 may be configured to authenticate (or re-authenticate) the user in the same manner as described herein with reference to operation 412 of FIG. 4. In various other examples, if the user has previously been authenticated by the user authentication circuitry 210, the smart mobile wallet management system 102 may not require that the user be authenticated a second time based on the mDL associated with the user. Additionally or alternatively, in some examples, the user authentication circuitry 210 may be configured to authenticate the user based on a second factor of authentication (e.g., biometric authentication, facial recognition, passcode, and/or the like). For example, if the smart mobile wallet management circuitry 212 determines that the second limit override confirmation indicates the user's approval of overriding the second transaction limit (e.g., the secondary transaction limit), the user authentication circuitry 210 may be configured to authenticate the user based on a second factor of authentication before the smart mobile wallet management circuitry 212 allows the transaction attempt to be fulfilled.

In some examples, if the smart mobile wallet management circuitry 212 determines that the second limit override confirmation indicates the user's approval to override the second transaction limit (e.g., the secondary transaction limit), the smart mobile wallet management circuitry 212 may be configured to proceed to operation 504 in which the transaction attempt is allowed. Alternatively, if the smart mobile wallet management circuitry 212 determines that the second limit override confirmation does not indicate the user's approval to override the second transaction limit (e.g., the secondary transaction limit), the smart mobile wallet management circuitry 212 may be configured to proceed to operation 512.

As shown by operation 512, the apparatus 200 may include means, such as processor 202, memory 204, communications hardware 206, smart mobile wallet management circuitry 212, and/or the like for denying the transaction attempt. For example the smart mobile wallet management circuitry 212 may be configured to deny (or flag for denial) the transaction attempt such that the transaction is cancelled, and no money is withdrawn from the payment account associated with the transaction attempt. As such, the smart mobile wallet management circuitry 212 may be configured to leverage the communications hardware 206 to provide instructions and/or information to one or more computing device associated with the merchant associated with the transaction attempt directing the merchant (or a clearinghouse, bank, or financial institution related to the merchant) to cancel, void, and/or otherwise disallow the transaction attempt.

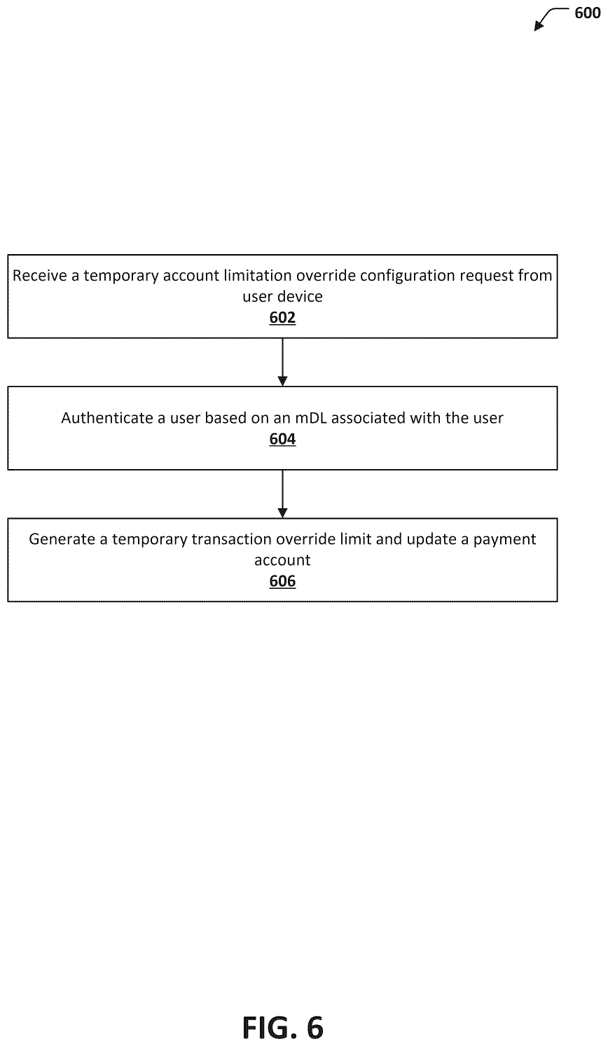

Turning now to FIG. 6, flowchart 600 illustrates example operations for configuring a temporary transaction override limit various aspects described herein.

As shown by operation 602, the apparatus 200 may include means, such as processor 202, memory 204, communications hardware 206, and/or the like for receiving a temporary account limitation override configuration request from a user device (e.g., user device 108A) associated with a user. In various examples, the temporary account limitation override configuration request is a request to enable a temporary transaction override limit that overrides one or more of the initial transaction limit or the secondary transaction limit associated with a payment account for a predetermined amount of time. As described herein, a temporary account limitation override configuration request may be generated for a user based on one or more interactions (e.g., user input, user selection) with a smart mobile wallet on a user device (e.g., user device 108A).

The temporary account limitation override configuration request may comprise a set of temporary account limitation override configuration parameters that are indicated by the user and define how a temporary transaction override limit are to be configured and/or utilized. In various examples, the set of temporary account limitation override configuration parameters may comprise one or more of a monetary value associated with a temporary transaction override limit, a temporary transaction override expiration date and/or time period, a temporary transaction geolocation restriction, a temporary merchant restriction, and/or one or more temporary transaction alert parameters (e.g., transaction attempt alert preferences, limit violation notification delivery preferences, and/or the like).

Furthermore, in some examples, the temporary account limitation override request may comprise an mDL and/or data associated with the mDL related to the user. For example, the temporary account limitation override request may be generated based on a user interaction with a smart mobile wallet and may indicate that the user desires to override the first transaction limit (e.g., the initial transaction limit) and the second transaction limit (e.g., the secondary transaction limit) associated with the payment account. In this regard, the smart mobile wallet circuitry 308 of a user device (e.g., user device 108A) may be configured to generate the temporary account limitation override request comprising one or more portions of mDL data associated with the mDL of the user. As such, the temporary account limitation override request may comprise one or more of cryptographic key information (e.g., public key information used to identify the mDL, a corresponding user device, and/or a corresponding user), originating IA data (e.g., cryptographic key information and/or identifying data associated with an originating IA), and/or other identifying data associated with the mDL of the user that is stored in the smart mobile wallet.

As shown by operation 604 the apparatus 200 may include means, such as processor 202, memory 204, communications hardware 206, mDL management circuitry 208, user authentication circuitry 210, smart mobile wallet management circuitry 212, and/or the like for authenticating the user based on the mDL associated with the user. For example, the user authentication circuitry 210 may be configured to leverage one or more of the communications hardware 206, the mDL management circuitry 208, and/or the smart mobile wallet management circuitry 212 to authenticate the user in response to receiving the temporary account limitation override request from the user device (e.g., user device 108A) associated with the user. In such examples, the user authentication circuitry 210 may be configured to authenticate (or re-authenticate) the user in the same or similar manner as described herein with reference to operation 412 of FIG. 4.

As shown by operation 606, the apparatus 200 may include means, such as processor 202, memory 204, smart mobile wallet management circuitry 212, and/or the like for generating a temporary transaction override limit and updating the payment account to include the temporary transaction override limit. For example, the smart mobile wallet management circuitry 212 may be configured to activate, enable, and/or otherwise initiate the use of the temporary transaction override limit described by the temporary account limitation override configuration request for the payment account. In some examples, the smart mobile wallet management circuitry 212 is configured to enable the temporary transaction override limit in response to a determination that the user has been successfully authenticated based on the user's mDL. As such, once the temporary transaction override limit is enabled for the payment account, the user may be permitted to make one or more transactions totaling a monetary amount less than or equal to the monetary value associated with the temporary transaction override limit.

In some examples, the monetary value associated with the temporary transaction override limit may be defined by the user and indicated by the temporary account limitation override configuration request (e.g., a user-defined monetary value that is higher relative to both the initial transaction limit and the secondary transaction limit). In other examples, the monetary value associated with the temporary transaction override limit may be associated with a total remaining monetary balance associated with the payment account. In such examples, configuring the payment account with the temporary transaction override limit enables the user to execute one or more transactions with a cumulative transaction amount less than or equal to the remaining monetary balance associated with the payment account.

Additionally or alternatively, in some examples, when the smart mobile wallet management circuitry 212 enables the temporary transaction override limit for the payment account, the smart mobile wallet management circuitry 212 may disable (e.g., deactivate, pause, and/or the like) one or more of the initial transaction limit or the secondary transaction limit associated with the payment account for the predetermined amount of time associated with the temporary transaction override limit. In such examples, the smart mobile wallet management circuitry 212 may be configured to automatically re-enable (e.g., reactivate, un-pause, and/or the like) the initial transaction limit or the secondary transaction limit associated with the payment account once the predetermined amount of time associated with the temporary transaction override limit has elapsed.

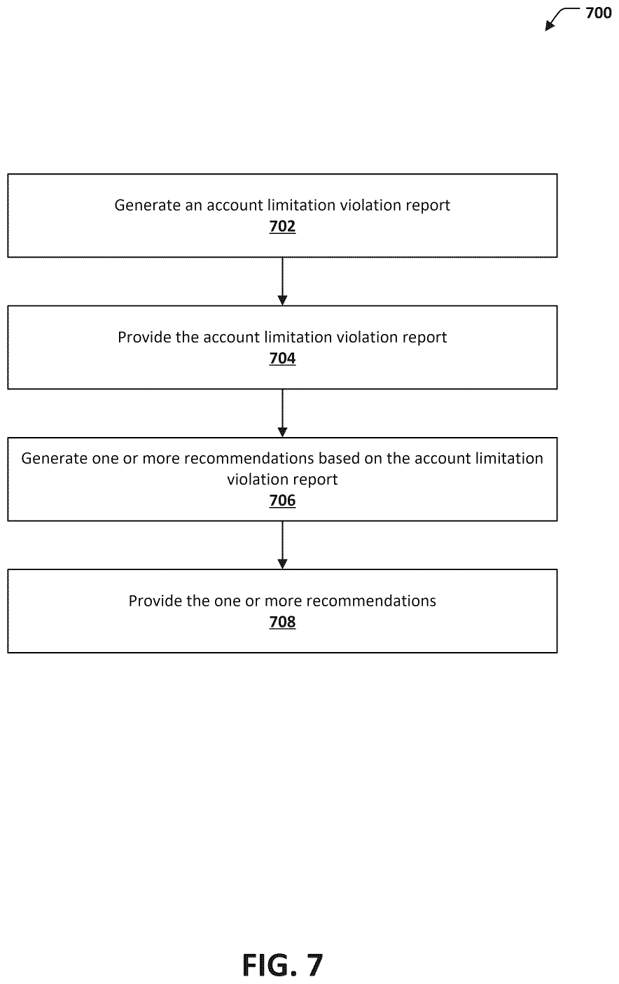

Turning now to FIG. 7, flowchart 700 illustrates example operations for generating an account limitation violation report and one or more recommendations in accordance with some example embodiments described herein.

As shown by operation 702, the apparatus 200 may include means, such as processor 202, memory 204, smart mobile wallet management circuitry 212, and/or the like for generating an account limitation violation report for one or more payment accounts associated with a user. For example, the smart mobile wallet management circuitry 212 may be configured to generate the account limitation violation report based in part on a transaction history associated with a payment account associated with one or more transaction limits (e.g., an initial transaction limit, secondary transaction limit, temporary transaction override limit, and/or the like). In some examples, a transaction history associated with the payment account may comprise data related to one or more withdrawals, purchases, deposits, transaction limit configurations, transaction limit overrides, and/or the like that were previously executed with respect to the payment account.

For example, the transaction history may indicate the date, time, and location a particular transaction was executed, an amount of money that was withdrawn from the payment account due to the particular transaction, a merchant identifier associated with the particular transaction, payment account data associated with the particular transaction, whether a respective transaction limit associated with payment account was exceeded by the transaction, whether the user authorized a limit override for the particular transaction, whether a secondary transaction limit was enabled during execution of the transaction, and/or the like. As such, in various examples, the account limitation violation report may comprise data compiled, aggregated, analyzed, and/or generated by the smart mobile wallet management circuitry 212 based on the transaction history associated with the payment account. In this regard, the smart mobile wallet management circuitry 212 may be configured to cause the storage of various data and/or information related to one or more transaction attempts, transaction limit configurations, transaction limit overrides, mDL-based user authentications, and/or the like associated with the payment account of the user.

The account limitation violation report may describe one or more insights related to various user patterns (e.g., spending patterns, transaction limit override patterns, and/or the like) associated with the payment account. For instance, the account limitation violation report may detail a percentage of transactions (e.g., purchase transactions) that exceeded one or more of an initial transaction limit, secondary transaction limit, and/or temporary transaction override limit associated with the payment account. For example, the account limitation violation report may describe that a first percentage of the transactions associated with the payment account (e.g., 74%, or any other percentage value) violated the initial transaction limit associated with the payment account. Similarly, as another example, the account limitation violation report may describe that a second percentage of the transactions associated with the payment account (e.g., 23%, or any other percentage value) violated the secondary transaction limit associated with the payment account.

Furthermore, in some examples, the account limitation violation report may describe how many times the smart mobile wallet management circuitry 212 received a limit override confirmation from the user authorizing that one or more of the initial transaction limit and/or the secondary transaction limit be overridden such that one or more transactions could be allowed. For example, the account limitation violation report may describe a percentage of the transactions that exceeded the initial transaction limit were ultimately authorized by the user and overridden such that the secondary transaction limit was enable for the payment account.

Additionally, in some examples, the account limitation violation report may describe various data related to one or more temporary transaction override limits that were configured for the payment account. For example, the account limitation violation report may indicate how many times the user enabled a temporary transaction override limit for the payment account. Furthermore, the account limitation violation report may indicate the dates, time period, and/or circumstances related to the temporary transaction override limit enabled for the payment account. In such examples, the account limitation violation report may also provide details related to one or more transactions that were executed during the time period associated with the temporary transaction override limit.

Additionally, in various examples, the account limitation violation report may further describe what percentage of transactions associated with the payment account required user authentication based on the mDL associated with the user. As described herein, the smart mobile wallet management system 102 may be configured to authenticate a user based on their mDL (e.g., an mDL comprised in a smart mobile wallet accessible via a user device 108A) before executing various operations. For example, the smart mobile wallet management system 102 may authenticate the user based on the mDL prior to configuring the payment account with one or more transaction limits (e.g., an initial transaction limit, secondary transaction limit, and/or temporary transaction override limit), and/or prior to enabling one or more of the transaction limits in response to receiving a limit override confirmation from a user device (e.g., user device 108A) associated with the user. As such, the account limitation violation report may describe data related to the dates, times, locations, purposes, and/or transaction attempts associated with one or more mDL-based user authentications executed with respect to one or more operations involving the payment account of the user.

In various examples, the smart mobile wallet management circuitry 212 may be configured to generate one or more account limitation violation reports according to a predefined schedule. For example, the smart mobile wallet management circuitry 212 may be configured to generate an account limitation violation report for a respective payment account every week, bi-weekly, every month, every quarter, semi-annually, annually, and/or the like. Furthermore, the smart mobile wallet management circuitry 212 may be configured to generate an account limitation violation report in variety of formats. For example, an account limitation violation report may be configured in a number of various file formats (e.g., in a PDF document format, word processing document format, spreadsheet document format, web-based document format (e.g., an HTML document file), and/or like).

As shown by operation 704, the apparatus 200 may include means, such as processor 202, memory 204, communications hardware 206, smart mobile wallet management circuitry 212, and/or the like for providing the account limitation report to the user. In various examples, the smart mobile wallet management circuitry 212 may be configured to retrieve various contact information (e.g., email addresses, phone numbers, computing device addresses, and/or the like) related to the user. As such, in some examples, the smart mobile wallet management circuitry 212 may be configured to leverage the communications hardware 206 to provide (e.g., transmit, deliver) the account limitation violation report to a user device (e.g., user device 108A) and/or user account (e.g., email account, enterprise account, and/or the like) associated with the user based on the various contact information.

As shown by operation 706, the apparatus 200 may include means, such as processor 202, memory 204, smart mobile wallet management circuitry 212, and/or the like for generating one or more recommendations based on the account limitation violation report. For example, the smart mobile wallet management circuitry 212 may be configured generate one or more recommendations for a user based on the one or more insights related to the various user patterns (e.g., spending patterns, transaction limit override patterns, and/or the like) associated with the payment account and described by the account limitation violation report. In some examples, the one or more recommendations may be included the account limitation violation report based on which the one or more recommendations were generated.

The one or more recommendations may include, but are not limited to, recommendations to adjust one or more transaction limits associated with the payment account (e.g., the initial transaction limit and/or the secondary transaction limit), recommended actions for improving financial hygiene, financial advice recommendations, and/or the like. As non-limiting example, if the account limitation violation report indicates that 50% (or any other predetermined percentage) of the transactions associated with the payment account exceeded (or contributed to exceeding) one or more transaction limits (e.g., an initial transaction limit and/or secondary transaction limit) associated with a daily time period, the smart mobile wallet management circuitry 212 may generate a recommendation to raise the monetary value associated with the initial transaction limit associated with the payment account. Additionally or alternatively, the smart mobile wallet management circuitry 212 may generate a recommendation to update (e.g., reconfigure) the one or more transaction limits from utilizing a daily time period, to utilizing a weekly time period with a higher monetary value relative to the previously configured transaction limits.

As another example, the smart mobile wallet management circuitry 212 may generate a recommendation that the user speak with a financial advisor from the enterprise associated with the smart mobile wallet management system 102. In this regard, one or more of the recommendations generated by the smart mobile wallet management circuitry 212 may be configured to comprise and/or integrate with one or more interactive user interface elements. As such, one or more of the recommendations generated by the smart mobile wallet management circuitry 212 may comprise one or more interactive hyperlinks, buttons, and/or the like configured to execute various commands associated with the one or more recommendations. By way of continued example, the recommendation that the user speak with a financial advisor may comprise an interactive button configured to initiate communication (e.g., telephone communication, web-based communication (e.g., live chat, video chat), and/or the like) with a respective financial advisor associated with the enterprise employing the smart mobile wallet management system 102. As another example, a recommendation that a user update (e.g., reconfigure, change) a respective transaction limit (e.g., an initial transaction limit), may comprise one or more interactive user interface elements configured to facilitate the updating of the transaction limit. In such an example, an interaction with the interactive user interface elements may cause a smart mobile wallet and/or web browser associated with the user device to provide a series of prompts to user to facilitate the updating of the transaction limit.

As shown by operation 708, the apparatus 200 may include means, such as processor 202, memory 204, communications hardware 206, smart mobile wallet management circuitry 212, and/or the like for providing the one or more recommendations to the user. For example, the smart mobile wallet management circuitry 212 may be configured to identify a smart mobile wallet associated with the user and leverage the communications hardware 206 to provide the one or more recommendations to the smart mobile wallet such that the user is made aware of the one or more recommendations. Additionally or alternatively, the smart mobile wallet management circuitry 212 may be configured to provide the one or more recommendations to the user via email, SMS, automated voice message, and/or the like. As such, in some examples, the smart mobile wallet management circuitry 212 may be configured to leverage the communications hardware 206 to provide (e.g., transmit, deliver) the one or more recommendations to a user device (e.g., user device 108A) and/or user account (e.g., email account, enterprise account, and/or the like) associated with the user.

FIGS. 4-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example User Interface

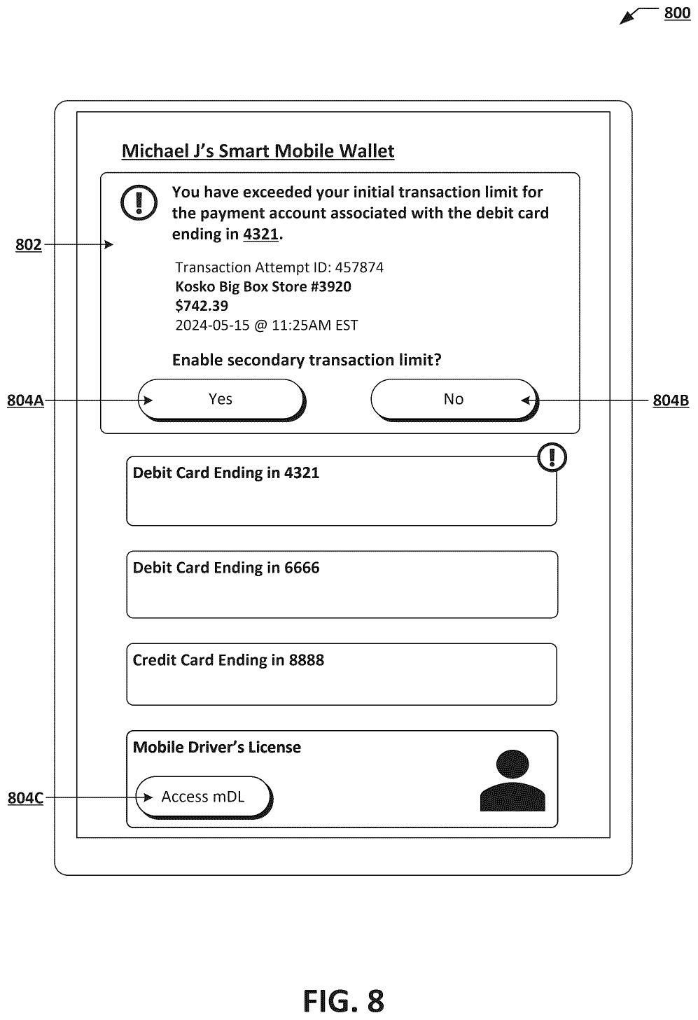

FIG. 8 depicts an example user interface corresponding to an example smart mobile wallet, access to which is enabled via a software application instance associated with the smart mobile wallet management system 102. Specifically, FIG. 8 illustrates an example user interface associated with a smart mobile wallet of a user. It will be appreciated that various configurations and/or layouts of user interfaces associated with the smart mobile wallets and/or software application instances associated with the smart mobile wallet management system 102 may be developed. Accordingly, the example depicted in FIG. 8 is provided for purposes of explanation and is not intended to limit the spirit and/or the scope of the present disclosure.

As described herein, a software application instance associated with the smart mobile wallet management system 102 may be configured to enable a user to access a smart mobile wallet (e.g., a digital wallet) configured to manage one or more of a user's mDL, payment accounts (e.g., credit accounts, checking accounts, savings accounts, investment accounts), payment cards (e.g., credit cards, debit cards, and/or the like associated with the user's payment accounts), and/or transaction limits (e.g., an initial transaction limit, secondary transaction limit, temporary transaction override limit, and/or the like) associated with one or more payment accounts that are associated with a respective enterprise employing the smart mobile wallet management system 102.

In this regard, the smart mobile wallet management circuitry 212 of the smart mobile wallet management system 102 may be configured to leverage the processor 202, the memory 204, and/or the communications hardware 206 to generate, cause transmission of, and/or cause display of a plurality of interactive user interface elements on a user interface associated with a software application instance associated with the smart mobile wallet management system 102 on a user device (e.g., user device 108A). The plurality of interactive user interface elements may be configured as one or more interactive text fields, buttons, selectable images, hyperlinks, radio buttons, sliders, embedded multimedia modules, charts, graphs, prompts, notifications, banners, instructions, and/or the like configured to initiate execution of one or more commands (e.g., executable software instructions) based on an interaction (e.g., user input) with the plurality of interactive user interface elements.

As illustrated in FIG. 8, an example user interface 800 associated with a smart mobile wallet of a user may comprise a limit violation notification (e.g., limit violation notification 802), one or more interactive user interface elements (e.g., interactive user interface elements 804A-804C), one or more digital representations of payment cards (e.g., the debit card ending in 4321), payments accounts, a digital representation of an mDL associated with the user, and/or the like.

As shown, a limit violation notification (e.g., limit violation notification 802) may be configured to describe a limit violation associated with a transaction attempt. For example, the limit violation notification (e.g., limit violation notification 802) may indicate that a transaction attempt associated with a respective debit card (e.g., debit card ending in 4321) is associated with a transaction amount that exceeds a respective transaction limit (e.g., an initial transaction limit) associated with the corresponding payment account. The limit violation notification (e.g., limit violation notification 802) may also be configured to provide details related to the transaction attempt that exceeded the transaction limit including, but not limited to, a transaction attempt identifier (e.g., transaction attempt ID 457874), a merchant identifier associated with the merchant involved in transaction attempt (e.g., Kosko Big Box Store #3920), a transaction amount (e.g., $742.39), and/or timestamp data associated with the transaction attempt (e.g., 2024-05-15 @11:25 AM EST). As depicted, a limit violation notification (e.g., limit violation notification 802) may also comprise one or more interactive user interface elements (e.g., interactive user interface elements 804A-804B).

In various examples, the one or more interactive user interface elements associated with the smart mobile wallet and/or the limit violation notification (e.g., interactive user interface elements 804A-804C) may be configured as interactive buttons that may be utilized to initiate various commands (e.g., executable software instructions) based one or more interactions (e.g., selections, indications, manipulations) with the interactive user interface elements. For example, the interactive user interface element 804A may be configured to enable a user to activate a secondary transaction limit associated with the payment account related to the transaction attempt. In some embodiments, a user interaction with the interactive user interface element 804A may initiate one or more operations related to generating and/or transmitting a limit override confirmation that indicates the user's desire to actively exceed and/or override a predetermined transaction limit associated with a payment account (e.g., the initial transaction limit associated with the account ending in 4321).

For example, based on the interaction with the interactive user interface element 804A, the smart mobile wallet circuitry 308 of a user device (e.g., user device 108A) may be configured to generate a limit override confirmation and cause the transmission of the limit override confirmation to the smart mobile wallet management system 102. Furthermore, in some examples, the smart mobile wallet circuitry 308 may be configured to generate a limit override confirmation comprising one or more portions of mDL data associated with the mDL of the user. As such, the limit override confirmation may comprise one or more of cryptographic key information (e.g., public key information used to identify the mDL, a corresponding user device, and/or a corresponding user), originating IA data (e.g., cryptographic key information and/or identifying data associated with an originating IA), and/or other identifying data associated with the mDL of the user that is stored in the smart mobile wallet.

As described herein, the user authentication circuitry 210 of the smart mobile wallet management system 102 may be configured to authenticate the user based on the mDL comprised in their smart mobile wallet based on one or more portions of mDL data comprised in the limit override confirmation. Furthermore, once the user is authenticated based in part on the limit override confirmation and the mDL comprised therein, the smart mobile wallet management circuitry 212 may be configured to enable the secondary transaction limit associated with the payment account related to the transaction attempt (e.g., transaction attempt ID 457874). Additionally, the smart mobile wallet management circuitry 212 may be configured to determine whether the transaction amount associated with the transaction attempt exceeds the secondary transaction limit. As such, if the smart mobile wallet management circuitry 212 determines that the transaction amount is less than the monetary value associated with the secondary transaction limit, the smart mobile wallet management circuitry 212 may be configured to cause the allowance of the transaction attempt and/or facilitate the transfer of funds from the payment account of the user to an account associated with the merchant involved in the transaction attempt.

The interactive user interface element 804B may be configured to enable a user to deny the enabling of a secondary transaction limit. In some examples, a user interaction with the interactive user interface element 804B may initiate one or more operations related to generating and/or transmitting a limit override confirmation that indicates the user's desire to maintain a predetermined transaction limit associated with a payment account (e.g., the initial transaction limit associated with the account ending in 4321). As such, if the first limit override confirmation indicates that the user does not wish to override the first transaction limit, the smart mobile wallet management circuitry 212 may be configured to deny the corresponding transaction attempt.

The interactive user interface element 804C may be configured to enable a user to access (e.g., view, manage, update, share, and/or the like) an mDL comprised in the smart mobile wallet associated with the user. In some examples, accessing the mDL via the interactive user interface element 804C may cause the display of one or more portions of credential data corresponding to the mDL associated with the user including, but not limited to, PII (e.g., given name, family name, name prefix, name suffix, driver's license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. As such, the smart mobile wallet may be configured to facilitate transactions requiring that the user provide proof of their identity (e.g., age-restricted transactions).

### CONCLUSION

As described above, example embodiments provide methods and apparatuses that enable improved payment account transaction control and management. Example embodiments thus provide tools (e.g., the various transaction limits described herein) that overcome the problems faced by conventional payment mechanisms and techniques. By avoiding the use of conventional payment mechanisms and techniques, example embodiments thus save time and resources, while also eliminating the possibility of a user unintentionally misusing monetary funds. Moreover, embodiments described herein counter a wide variety of emerging risks in an evolving technological landscape.

Example embodiments also reduce the technical complexity of managing a payment account (e.g., a checking account, savings account) for a user. For example, example embodiments eliminate the need for a user to log into an enterprise account (e.g., a user account associated with a financial institution) in order to enable, configure, update, and/or otherwise configure one or more transaction limits for a respective payment account. Example embodiments also provide the benefit of enabling a user to enforce various transaction limits, budgets, spending restrictions, and/or circumstances related to how certain funds are spent by the user. Furthermore, example embodiments provide additional layers of security for the funds associated with a payment account equipped with an initial transaction limit and/or a secondary transaction limit such that the user may be notified if an unusual transaction attempt (e.g., a transaction attempt associated with a non-routine amount of money) is being attempted.

Moreover, example embodiments contemplated herein provide technical solutions that solve real-world problems faced by users who wish to ensure the safety of various transaction and/or account management operations by employing various mDL-based user authentication techniques. And while confirming the identity of an individual has been a technical challenge for years, the increasing occurrence of credit card fraud, bank account fraud, and transaction fraud (both on the web and in physical retail locations) has made this problem significantly more acute. By utilizing a legally-issued mDL to authenticate a user, embodiments of the present disclosure ensure that users are properly verified before a payment account is configured and/or the allowance for various transactions is granted, thereby increasing the security and safety of the funds associated with the payment account equipped with the various transaction limits described herein (e.g., initial transaction limits, secondary transaction limits, and/or temporary transaction override limits).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing account transaction control and management, the method comprising:
receiving, by communications hardware, a transaction attempt associated with a payment account of a user, wherein the payment account includes an initial transaction limit and a secondary transaction limit;
determining, by smart mobile wallet management circuitry, whether a transaction amount of the transaction attempt exceeds the initial transaction limit;
in response to determining the transaction amount exceeds the initial transaction limit, providing, by the communications hardware, a first limit violation notification to the user;
receiving, by the communications hardware and based on the first limit violation notification, a first limit override confirmation from the user, wherein the first limit override confirmation comprises a mobile driver's license (mDL) associated with the user;
authenticating, by user authentication circuitry and based on the first limit override confirmation, the user based on the mDL; and
in response to successfully authenticating the user, enabling, by the smart mobile wallet management circuitry, the secondary transaction limit associated with the payment account.

2. The method of claim 1, further comprising:
receiving, by the communications hardware, an account limitation configuration request from a user device associated with the user; and
in response to receipt of the account limitation configuration request, updating, by the smart mobile wallet management circuitry and based on the account limitation configuration request, the payment account to include the initial transaction limit and the secondary transaction limit.

3. The method of claim 1, further comprising:
determining, by the smart mobile wallet management circuitry, whether the transaction amount of the transaction attempt exceeds the secondary transaction limit; and
in response to determining the transaction amount of the transaction attempt does not exceed the secondary transaction limit, allowing, by the smart mobile wallet management circuitry, the transaction attempt.

4. The method of claim 3, further comprising:
in response to determining the transaction amount of the transaction attempt exceeds the secondary transaction limit, providing, by the communications hardware, a second limit violation notification to the user;
receiving, by the communications hardware and based on the second limit violation notification, a second limit override confirmation from a user device; and
allowing or denying, by the smart mobile wallet management circuitry, the transaction attempt.

5. The method of claim 4, wherein providing one or more of the first limit violation notification or the second limit violation notification further comprises causing display of the first limit violation notification or the second limit violation notification via one or more of a point-of-sale terminal associated with the transaction attempt, the user device, or a smart mobile wallet associated with the user.

6. The method of claim 1, further comprising:
determining, by the smart mobile wallet management circuitry, whether the payment account is linked to a smart mobile wallet associated with the user; and
in an instance in which the payment account is not linked to the smart mobile wallet:
receiving, by the communications hardware, payment account data associated with the payment account from a user device, and
linking, by the smart mobile wallet management circuitry and based on the payment account data, the payment account to the smart mobile wallet such that one or more transaction attempts associated with the payment account are facilitated via the smart mobile wallet.

7. The method of claim 1, wherein authenticating the user further comprises authenticating, by the user authentication circuitry, the user based on a secondary authentication factor provided by a user device.

8. The method of claim 1, further comprising:
receiving, by the communications hardware, a temporary account limitation override configuration request, wherein the temporary account limitation override configuration request is a request to override one or more of the initial transaction limit or the secondary transaction limit for a predetermined amount of time and comprises the mDL associated with the user;
authenticating, by the user authentication circuitry and based on the temporary account limitation override configuration request, the user based on the mDL associated with the user;
in response to authenticating the user, generating, by the smart mobile wallet management circuitry and based on the temporary account limitation override configuration request, a temporary transaction override limit, wherein the temporary transaction override limit may be higher than one or more of the initial transaction limit or the secondary transaction limit; and
updating, by the smart mobile wallet management circuitry, the payment account with the temporary transaction override limit.

9. The method of claim 8, further comprising disabling, by the smart mobile wallet management circuitry, one or more of the initial transaction limit or the secondary transaction limit for the predetermined amount of time.

10. The method of claim 1, further comprising:
generating, by the smart mobile wallet management circuitry, an account limitation violation report associated with payment account; and
providing, by the communications hardware, the account limitation violation report to the user.

11. The method of claim 10, further comprising:
generating, by the smart mobile wallet management circuitry and based on the account limitation violation report, one or more recommendations; and
providing, by the communications hardware, the one or more recommendations to the user.

12. The method of claim 1, wherein authenticating the user based on the mDL further comprises:
executing, by the user authentication circuitry and based on the first limit override confirmation, an mDL authentication request, wherein the mDL authentication request is a request to authenticate the mDL associated with the user;
generating, by mDL management circuitry and based on the mDL authentication request, a digital token;
transmitting, by the communications hardware, the digital token to an issuing authority (IA) system associated with an IA that provisioned the mDL to the user;
receiving, by the communications hardware and from the IA system, an mDL validity response, wherein the mDL validity response is generated based on the digital token, and wherein the mDL validity response indicates verified credential data associated with the mDL; and
authenticating, by the user authentication circuitry, the user based on the mDL validity response.

13. The method of claim 12, wherein the mDL authentication request comprises one or more of user identification data, desired credential data associated with the mDL, or user attribute data associated with the user.

14. The method of claim 13, wherein the mDL validity response further indicates verified user device identification data related to a user device associated with the user.

15. An apparatus for providing account transaction control and management, the apparatus comprising:
communications hardware configured to:
receive a transaction attempt associated with a payment account of a user, wherein the payment account includes an initial transaction limit and a secondary transaction limit;
smart mobile wallet management circuitry configured to:
determine whether a transaction amount of the transaction attempt exceeds the initial transaction limit,
wherein the communications hardware is configured to provide, in response to determining the transaction amount exceeds the initial transaction limit, a first limit violation notification to the user,
wherein the communications hardware is configured to receive, based on the first limit violation notification, a first limit override confirmation from the user, and wherein the first limit override confirmation comprises a mobile driver's license (mDL) associated with the user; and
user authentication circuitry configured to:
authenticate, based on the first limit override confirmation, the user based on the mDL,
wherein the smart mobile wallet management circuitry is configured to enable, in response to successfully authenticating the user, the secondary transaction limit associated with the payment account.

16. The apparatus of claim 15, wherein the communications hardware is further configured to:
receive an account limitation configuration request from a user device associated with the user; and
the smart mobile wallet management circuitry is further configured to:
update, in response to receipt of the account limitation configuration request, the payment account to include the initial transaction limit and the secondary transaction limit.

17. The apparatus of claim 15, wherein the smart mobile wallet management circuitry is further configured to:
determine whether the transaction amount of the transaction attempt exceeds the secondary transaction limit; and
in response to a determination that the transaction amount of the transaction attempt does not exceed the secondary transaction limit, allow the transaction attempt.

18. The apparatus of claim 17, wherein the communications hardware is further configured to:
in response to a determination that the transaction amount of the transaction attempt exceeds the secondary transaction limit, provide a second limit violation notification to the user; and
receive, based on the second limit violation notification, a second limit override confirmation from a user device,
wherein the smart mobile wallet management circuitry is configured to allow or deny the transaction attempt based on the second limit violation notification.

19. A system comprising:
means for receiving a transaction attempt associated with a payment account of a user, wherein the payment account includes an initial transaction limit and a secondary transaction limit;
means for determining whether a transaction amount of the transaction attempt exceeds the initial transaction limit;
in response to determining the transaction amount exceeds the initial transaction limit, means for providing a first limit violation notification to the user;
means for receiving, based on the first limit violation notification, a first limit override confirmation from the user, wherein the first limit override confirmation comprises a mobile driver's license (mDL) associated with the user;
means for authenticating, based on the first limit override confirmation, the user based on the mDL; and
in response to successfully authenticating the user, means for enabling the secondary transaction limit associated with the payment account.

20. The system of claim 19, further comprising:
means for receiving an account limitation configuration request from a user device associated with the user; and
means for updating, in response to receipt of the account limitation configuration request, the payment account to include the initial transaction limit and the secondary transaction limit.
